(19) United States
(12) Patent Application Publication
(10) Pub. No.: US 2026/0082266 A1
(43) Pub. Date: Mar. 19, 2026

(54) Enhanced Edge Application Server Discovery Function for Service Discovery in Cellular Networks

(71) Applicant: Intel Corporation, Santa Clara, CA (US)

(72) Inventors: Zongrui Ding, Redmond, WA (US); Changhong Shan, Shanghai (CN); Alexandre Saso Stojanovski, Paris (FR); Qian Li, Beaverton, OR (US)

(73) Assignee: Intel Corporation, Santa Clara, CA (US)

(21) Appl. No.: 19/393,305

(22) Filed: Nov. 18, 2025

Related U.S. Application Data
(60) Provisional application No. 63/721,915, filed on Nov. 18, 2024.

(51) Int. Cl. H04W 28/02; H04W 48/16; H04W 48/18

(52) U.S. Cl. CPC H04W 28/0215; H04W 48/16; H04W 48/18

(57) ABSTRACT

An enhanced Edge Application Server Discovery Function (eEASDF) for service discovery in cellular networks, addresses the limitations of static and DNS-based discovery mechanisms. The eEASDF dynamically matches user equipment (UE) requests with edge application servers (EAS) based on detailed filters, such as compute resource requirements, quality-of-service objectives, and location scope. Utilizing Protocol Configuration Options (PCO), the eEASDF can facilitate efficient service discovery by integrating metadata and telemetry from a Unified Data Repository (UDR) or Service Repository Function (SRF). This functionality can support user-plane traffic steering through PDU session modifications, uplink classifier updates, and user plane function reselection. The described technology enhances latency performance, reduces rediscovery churn, and optimizes resource allocation for compute-intensive applications in next-generation networks. Primary applications can include augmented reality, real-time analytics, and AI-assisted services.

### CROSS REFERENCE TO RELATED APPLICATIONS

This application claims benefit to U.S. Provisional Patent Application Ser. No. 63/721,915, filed Nov. 18, 2024, titled “ENHANCED EDGE APPLICATION SERVER DISCOVERY FUNCTION (EASDF) FOR SERVICE DISCOVERY IN NEXT GENERATION CELLULAR NETWORKS”, which is incorporated by reference herein in its entirety.

### BACKGROUND

In modern cellular networks, the proliferation of edge computing platforms has become a significant factor in addressing ever-increasing demands for low-latency, high-throughput services. Network operators are deploying distributed compute resources close to end users to support applications ranging from augmented reality to real-time analytics and artificial seamless service invocation and data offload, ensuring that user equipment (UE) can efficiently locate and connect with appropriate edge servers. As next-generation networks evolve, the ability to dynamically discover and select edge application endpoints supports the quality of experience for a broad array of latency-sensitive and resource-intensive use cases.

Service discovery in cellular networks serves the important purpose of directing UEs to edge servers capable of satisfying application requirements while optimizing network resource utilization. Beyond simple name resolution, there is a growing expectation that discovery mechanisms can convey richer metadata—such as processing capacity, service latency, workload characteristics, and quality-of-service (QOS) parameters—to enable intelligent selection. Operators aim to orchestrate compute workloads dynamically, scaling resources based on real-time demand and ensuring that UEs are steered to the most suitable compute instance. Effective discovery mechanisms thus play a significant role in aligning user demands with available network and edge resources.

Existing discovery approaches in current 5G systems predominantly leverage DNS-style resolution techniques or static filter templates provisioned via network configuration channels. While DNS-based resolution offers familiarity and wide support, this method is restricted to domain-name mapping and lacks granularity in expressing compute-related attributes.

Alternatively, filter-based discovery schemes can include additional descriptors but often rely on preconfigured, static templates that do not adjust to changing workload or network conditions. These approaches can lead to suboptimal server selection, unnecessary discovery loops, and increased signaling overhead when UEs are required to reinitiate discovery procedures to address evolving service requirements.

A significant challenge lies in bridging the gap between coarse-grained, static discovery mechanisms and the dynamic needs of emerging compute-intensive applications. UEs require the ability to articulate specific resource and workload requirements—such as desired CPU cycles, memory bandwidth, hardware accelerators, or processing duration—in discovery requests. Simultaneously, the network is expected to leverage up-to-date registration data for edge servers, including performance metrics and availability status, to generate precise candidate lists. Without a streamlined, end-to-end discovery framework that integrates rich resource descriptors and dynamic session management, service invocation can incur latency penalties, inefficient resource usage, and degraded user experience.

### BRIEF DESCRIPTION OF THE DRAWINGS

FIG. 1 illustrates an example Protocol Configuration Options (PCO) information element used to convey resolver and service discovery configuration.

FIG. 2 illustrates a sequence for registering edge application server information into a repository accessible for discovery according to an embodiment.

FIG. 3 illustrates a sequence for service discovery and user-plane steering toward a selected enhanced edge application server according to an embodiment.

FIG. 4 illustrates an example wireless network capable of supporting edge service discovery.

FIG. 5 illustrates functional components of a user equipment and an access node for layered processing and communication.

FIG. 6 illustrates a block diagram of hardware resources suitable for implementing the described functions.

FIG. 7 illustrates a high-level Open RAN architecture.

FIG. 8 illustrates an Open RAN logical architecture.

FIG. 9 illustrates a next-generation network including computing, communication, and data service planes.

FIG. 10 illustrates AI-assisted communication between a user equipment and a radio access network.

FIG. 11 illustrates a flow diagram of an example process performed in accordance with the described embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

Fifth generation (5G) edge server discovery is specified in the Third Generation Partnership Project (3GPP) Technical Specification (TS) 23.548, in which the Edge Application Server Discovery Function (EASDF) acts as a Domain Name System (DNS) resolver for a User Equipment (UE) to modify DNS requests or responses so that the UE could choose an Edge Application Server (EAS) which may be close to the UE. See 3GPP TS 23.548 V19.0.0 (2024-09) (hereinafter “TS23.548-September 2024”).

In particular, the Session Management Function (SMF) provisions the UE with EASDF resolver parameters using Protocol Configuration Options (PCO) so that application-layer DNS queries resolve through operator-selected resolvers; EASDF may apply DNS message handling rules, including insertion of extension mechanisms for DNS Client Subnet (EDNS Client Subnet), forwarding to central or local DNS, and temporary buffering or suppression of responses while user-plane anchoring is updated for breakout via a Local PDU Session Anchor (L-PSA) using an Uplink Classifier (UL CL) or Branching Point; these actions support proximity-based selection and can trigger rediscovery upon mobility or topology change. See TS23.548-September 2024.

DNS-based service discovery has some limitations especially for sixth generation (6G) computing scenarios. DNS requests carry limited information which doesn't include rich information about computing such as computing resource requirements in terms of capacity, response time or special hardware/software (HW/SW). This may result in a discovered EAS not suitable to serve UE's service requirements and a rediscovery will be triggered. Modern cloud computing usually combines the traditional DNS approach and the service registration and filter-based queries for efficient service discovery. See TS23.548-September 2024.

Consistent with core architecture, 3GPP TSG-SA WG2 Meeting #143E (e-meeting)-Feb. 24-Mar. 9, 2021, Elbonia (revision of S2-210xxxx) (hereinafter “TS 23.501-March 2021”) describes connectivity models that interact with discovery outcomes, including distributed anchoring at an L-PSA near the UE, session breakout from a central anchor using UL CL or a Branching Point toward local anchors, and multiple PDU sessions that separate edge-bound traffic from other services; anchor changes may occur due to mobility, with UE Route Selection Policies (URSP) steering application flows accordingly. See TS 23.501-March 2021.

In 3GPP Service and System Aspects Working Group 6 (SA6), filter-based service discovery requires additional configuration from the Edge Configuration Server (ECS) to the UE via the User Plane (UP). The configuration is usually static and not dynamic enough to work with service orchestration in a 6G scenario. For example, the SA6 approach may rely on area validation to trigger UE to request new configurations from the ECS or connect to a different ECS. See 3GPP TS 23.558 V19.3.0 (2024-09) (hereinafter “TS23.558-September 2024”).

Within this SA6 framework, an Edge Enabler Client (EEC) interacts with Edge Enabler Servers (EESs) to obtain EAS lists using discovery filters that can include location, service Key Performance Indicators (KPIs), instantiation status, and continuity attributes; federation and roaming can be supported via ECS profiles that include spatial validity and partner information, with exposure to the core through a Network Exposure Function (NEF) and Common API Framework (CAPIF) where applicable.

Protocol Configuration Options (PCO), as defined in 3GPP TS 24.008 V19.0.0 (2024-09) (hereinafter “TS24.008-September 2024”), are Non-Access Stratum (NAS) information elements that carry configuration during session establishment and modification, including primary and secondary DNS server addresses for IPV4/IPv6, IP control protocol identifiers, and containerized options; the PCO information element structure includes identifiers, length fields, and sub-options that allow the network to deliver resolver parameters to the UE and later refresh them when anchoring or discovery policy changes.

PCO carriage across NAS procedures allows the SMF to align the UE's DNS client behavior with current user-plane paths, enabling updates when the network reselects anchors, adjusts Data Network Access Identifiers (DNAIs), or applies rediscovery triggers; this helps keep name-to-address mappings consistent with breakout to local data networks and mitigates stale resolution following mobility or edge site changes.

According to some embodiments, EASDF may be enhanced with a filter-based service registration and query for service discovery. The enhanced Edge Application Server Discovery Function (eEASDF) is named herein as eEASDF. The related configurations can follow similar approaches such as using PCO to be sent to UE to ensure efficiency.

Some embodiments relate to the manner in which eEASDF may leverage dynamic information about EAS and EES for UE's service discovery using Hypertext Transfer Protocol (HTTP) request/response, i.e., filter-based or service repository-based. eEASDF can also trigger a Packet Data Unit (PDU) session establishment/modification to prepare UP based on UE's service discovery. See TS23.548-September 2024 and TS24.008-September 2024.

In some embodiments, eEASDF operates as a dual-plane function: on the control plane it aggregates EAS/EES registrations and telemetry into a Unified Data Repository (UDR) or Service Repository Function (SRF), and on the data plane it coordinates with a SMF to realize UL CL updates or L-PSA reselection when discovery outcomes require traffic steering toward a selected edge site.

As used herein, the term ‘UDR/SRF’ refers to the Unified Data Repository (UDR) and/or a Service Repository Function (SRF) that store edge application server context, including static profiles and dynamic telemetry, accessible by eEASDF for service discovery.

EASDF in the state of the art acts as a DNS resolver for a UE to modify the DNS requests and responses. SA6 approach uses filter-based service discovery. See TS23.548-September 2024 and TS23.558-September 2024.

To bridge the DNS path and filter-based selection, eEASDF according to some embodiments can expose HTTP discovery endpoints referenced by PCO-delivered Uniform Resource Locators (URLs), allowing UE to submit filter templates that reference capabilities, KPIs, or instantiation status; responses can return candidate EAS identities, addresses, and validity scopes aligned with DNAIs.

The Service and System Aspects Working Group 2 (SA2) approach discovers EES without rich information, which may result in the discovered EAS not satisfying the computing-related requirements thus re-discovery of the EAS. See TS 23.501-March 2021.

SA6 approach requires interaction between UE (EEC) and ECS/EES for configurations before any filter-based service discovery can happen. See TS23.558-September 2024.

In embodiments, eEASDF may handle filter-based EAS discovery which is configured by PCO. eEASDF can query the EAS information stored in the UDR or SRF to get an EAS candidate list based on the UE's EAS discovery request. If the PDU session needs to be modified, eEASDF can request to the SMF for a PDU Session modification.

PCO, as defined in 3GPP TS 24.008, can carry DNS resolver Internet Protocol (IP) addresses, discovery protocol indicators, and containerized filter templates or references; during PDU Session Establishment and PDU Session Modification, updated PCO values enable the network to refresh UE's discovery configuration so that subsequent HTTP requests and DNS resolutions align with current anchoring and policy.

Upon confirmation of an EAS selection, eEASDF can notify SMF with the Fully Qualified Domain Name (FQDN) mapping and selected EAS IP address so SMF can program UL CL rules or reselect a L-PSA for breakout; eEASDF may temporarily buffer or suppress DNS responses while user-plane updates complete, then release resolution results to minimize service disruption.

The cloudification of the telecommunication network may result in high demand for computing and Artificial Intelligence/Machine Learning (AI/ML). Accordingly, according to embodiments, consolidating discovery metadata, delivery via PCO, and coordinated user-plane steering within eEASDF advantageously improves latency, reduces rediscovery churn, and better aligns compute placement with workload requirements under mobility and variable load.

PCO Configurations about Service Discovery

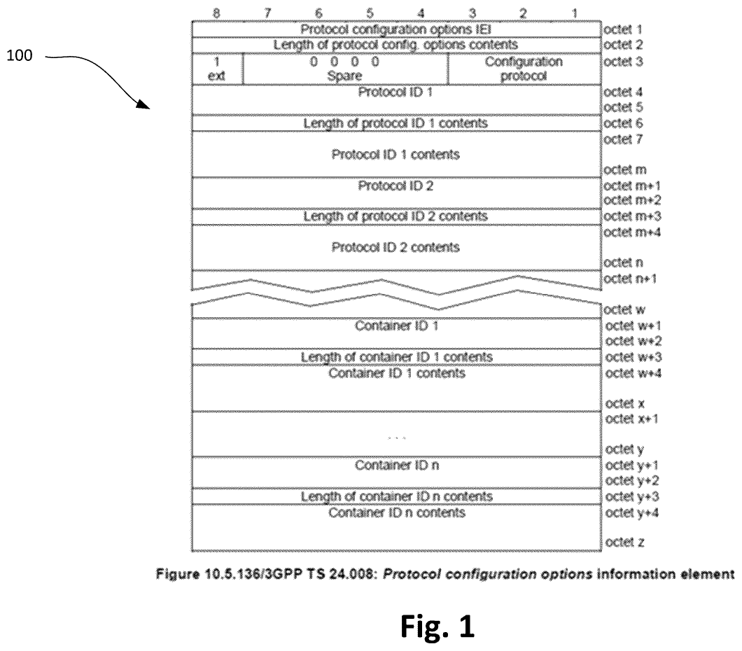

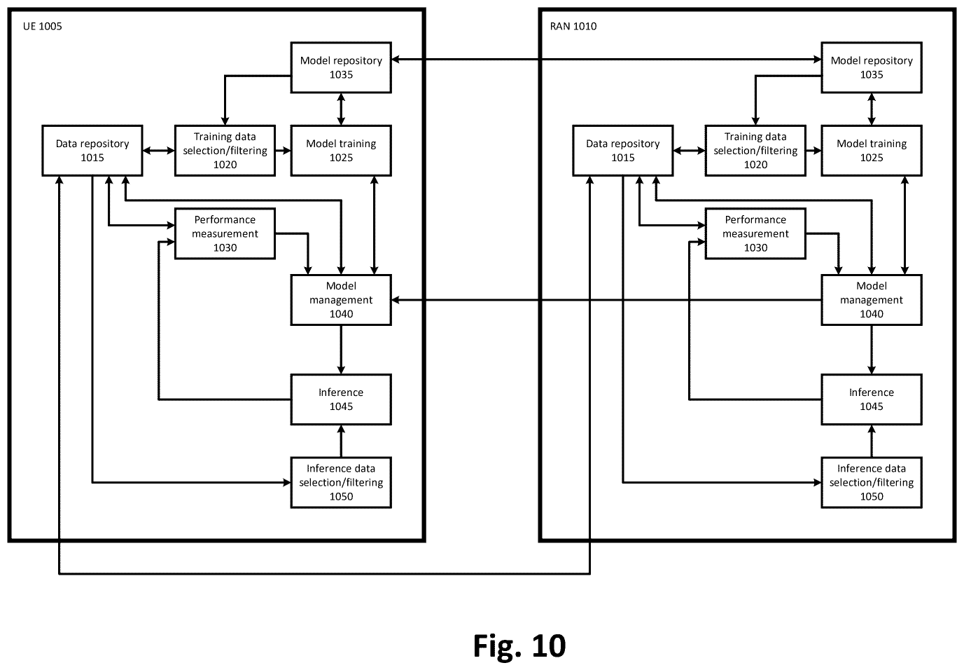

PCO is a component of NAS message and this component can be carried by many different messages as specified in and FIG. 1, which shows an example PCO information element structure 100, corresponding to that shown in FIG. 10.5.136 of TS24.008-September 2024.

In particular, as suggested in FIG. 1, PCO is an information element with identifiers, length, and sub-options, supporting DNS server addresses, IP control protocol identifiers, and containerized vendor-specific or service configuration parameters used during PDU Session Establishment and PDU Session Modification to provision or refresh discovery settings to UE. See TS24.008-September 2024.

FIG. 1 illustrates a PCO information element used in NAS signaling to convey resolver and discovery configuration from the network to UE in a structured, length-delimited format.

As shown, the information element 100 begins with an information-element identifier field and an overall length field that together allow a receiver to recognize the element and determine the exact number of octets to parse for the PCO contents. These leading fields are followed by an octet that includes the “ext” bit and a configuration-protocol nibble, establishing the parsing context for the subsequent sub-options.

Below this header, the element 100 is organized into two ordered sections: a sequence of one or more “Protocol ID i” blocks and a sequence of one or more “Container ID i” blocks. Each Protocol ID block carries its own length and contents, enabling standardized options such as IP control protocols and primary/secondary DNS server addresses for IPV4/IPV6 to be delivered so the UE's resolver stack uses operator-selected resolvers aligned with the current PDU session and policy.

Each Container ID block likewise carries its own length and contents, providing a standards-compliant encapsulation for vendor-specific or service-specific data.

In the context of some embodiments, a dedicated computing-service-discovery container within element 100 is provided, which may include enhanced EASDF endpoints, URLs, Data Network Names, Single Network Slice Selection Assistance Information (S-NSSAIs) values, and filter templates that the UE may use to issue HTTP filter-based discovery requests to the enhanced discovery function.

Because each sub-option is length-prefixed, SMF can update only the relevant entries during PDU Session Establishment and PDU Session Modification, allowing the network to refresh resolver addresses and discovery templates when user-plane anchoring, Uplink Classifier or L-PSA selection, or policy changes require rediscovery or re-anchoring. This advantageously enables immediate and synchronized configuration of UE's discovery behavior with the network's current edge steering decisions using the single PCO information element 100.

Some embodiments recognize that there are many container IDs defined already for different configurations. To enable additional service discovery configuration container, a new container ID for computing service discovery may be used according to some embodiments.

The PCO container content may, according to some embodiments, include one or more of the following example elements:
The protocol used for service discovery, e.g., HTTP, JavaScript Object Notation (JSON). PCO can advertise discovery protocol indicators so that UE directs requests to network-selected endpoints aligned with policy. The protocol used for service discovery, e.g., HTTP, JavaScript Object Notation (JSON). PCO can advertise discovery protocol indicators so that UE directs requests to network-selected endpoints aligned with policy.
The eEASDF configuration information according to some embodiments e.g., concrete connection details such as IP addresses, port numbers, and URLs, plus identifiers that bind discovery to a particular data network and slice, namely the Data Network Name (DNN) and the Single Network Slice Selection Assistance Information (S-NSSAI). Including IP/port/URL gives the UE an authoritative endpoint for HTTP-based, filter-oriented discovery; including DNN and S-NSSAI ensures the request is scoped to the correct data network and slice context that the core uses for selecting SMF/UPF and enforcing QoS and policy. This combination aligns discovery outcomes with the operator's configured edge breakout path, for example, using UL control plane/data plane (CL/BP) toward an L-PSA close to the UE.
The service discovery filter templates used for service discovery such as application ID, computing capabilities, QoS requirements, AI/ML capabilities such as training or inference, etc. Templates may correspond to SA6 discovery parameters (e.g., location scope, instantiation status, KPIs) to enable harmonized requests by EEC. Service discovery relies on structured “filter templates” carried to, or known by, the UE so discovery requests can precisely declare requirements and constraints according to some embodiments. Typical fields include application identifiers, minimum/target compute capabilities (e.g., accelerators, memory, CPU), QoS objectives, and AI/ML attributes such as whether training or inference is needed; SA6 adds context fields like the geographic validity of service (location scope), whether an instance is instantiated or only potential (instantiation status), and expected/minimum service KPIs. By aligning the template schema with SA6's information model, the EEC can, according to some embodiments, advantageously submit interoperable filter queries that EES resolves against registered EAS profiles and telemetry, improving match quality and reducing rediscovery.

According to some embodiments, similar to other PCOs, UE can request the computing service discovery PCOs in the session establishment request and get the PCO configurations from the network (NW) as a response. Subsequent PDU Session Modification can refresh these PCO values when SMF changes anchoring or policy, keeping UE discovery aligned with current UL CL and L-PSA paths.

5.1.2 EAS Registration to eEASDF

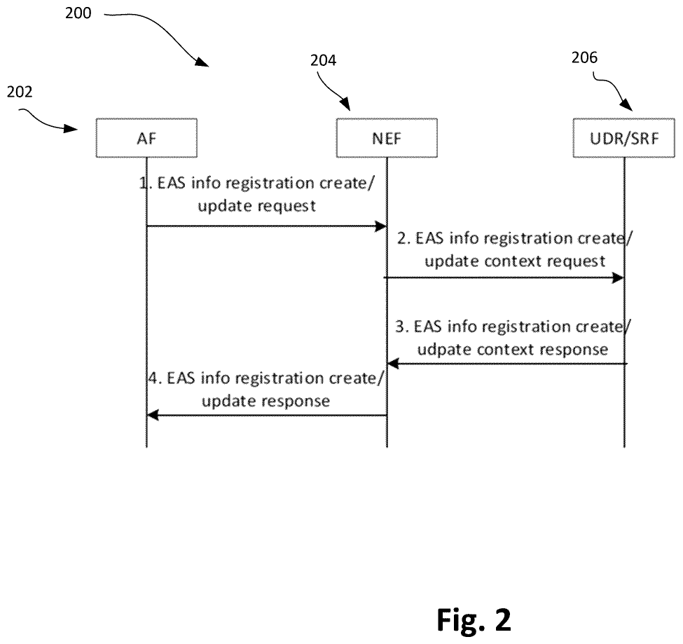

FIG. 2 shows a sequence diagram 200 illustrating a registration of edge application server information into a repository accessible for discovery according to some embodiments.

According to some embodiments Section 5.1.2 or a similar section of TS23.548 may be changed to reflect the following flow.

Per elements 1 and 2 of FIG. 2, Application Function (AF) 202 sends an EAS information registration create/update request to Network Exposure Function (NEF) 204 to register the EAS or update its status to the cellular network. NEF 204 then forwards an EAS information registration create/update context request to the Unified Data Repository/Service Repository Function (UDR/SRF) 206. This request may include static information such as the EAS profile information (e.g., EASID, EAS endpoints) and dynamic information such as performance metrics (end-to-end delay), computing resource occupancy, and similar telemetry. This information is created as EAS context information in the UDR/SRF 206. The registration enables eEASDF to later perform attribute-based matching against UE filters and to expose candidate lists coherent with DNAIs and spatial validity. In some embodiments, the request from AF 202 to NEF 204 includes correlation identifiers, timestamps, and an operation type (create versus update) to ensure idempotent handling, while NEF 204 performs authentication/authorization and policy checks before transforming the request into a repository-native schema for UDR/SRF 206. The context written into UDR/SRF 206 may be indexed by EASID, DNN, S-NSSAI, geographic validity, and workload capabilities, and include freshness indicators (e.g., last-update time, telemetry version) to support subsequent discovery queries by eEASDF. NEF 204 can also enforce rate limiting and exposure policies, and may establish subscriptions so that changes in registered attributes are reported to interested consumers (e.g., eEASDF) in near real time.

Per elements 3 and 4 of FIG. 2, the UDR/SRF 206 sends an EAS information registration create/update context response to NEF 204, which in turn sends an EAS information registration create/update response to AF 202 to indicate the result of the registration. If the registration is not successful, a cause may be included. This response is sent to AF 202 via NEF 204. Policies can constrain visibility or selection, and causes may guide AF retries or updates; successful writes make attributes immediately queryable by discovery functions. The response from UDR/SRF 206 may include a repository-generated version or etag of the stored context, a validity interval, and optional warnings if certain attributes were normalized or rejected by policy. NEF 204 may translate internal cause codes into standardized error semantics for AF 202, and the response can carry a subscription handle (where supported) allowing AF 202 to receive asynchronous notifications of subsequent context changes.

Note that if AF 202 belongs to the same domain as the UDR/SRF 206, NEF 204 may not be required. In such deployments, AF 202 can interface directly with UDR/SRF 206 over a trusted service-based interface, using the same create/update semantics shown in FIG. 2 (steps 2 and 3), and may still include correlation identifiers, versioning, and subscription requests to maintain consistent lifecycle behavior and discoverability for eEASDF.

Based on the EAS context information, eEASDF can query the UDR/SRF 206 to obtain EAS-related information for service discovery using a different protocol, such as HTTP-based information filters. eEASDF can cache or subscribe to changes and, upon significant updates (e.g., instantiation state, KPI thresholds), prompt UE rediscovery via updated PCO or respond with revised candidate sets. To align with the FIG. 2 flow, eEASDF may utilize the same identifiers and version fields returned during registration to ensure coherent reads, favoring contexts with the most recent telemetry and within their declared validity scope for accurate candidate selection.

### Message Flow For Service Discovery And Configurations Using Filter-Based Enhanced EASDF

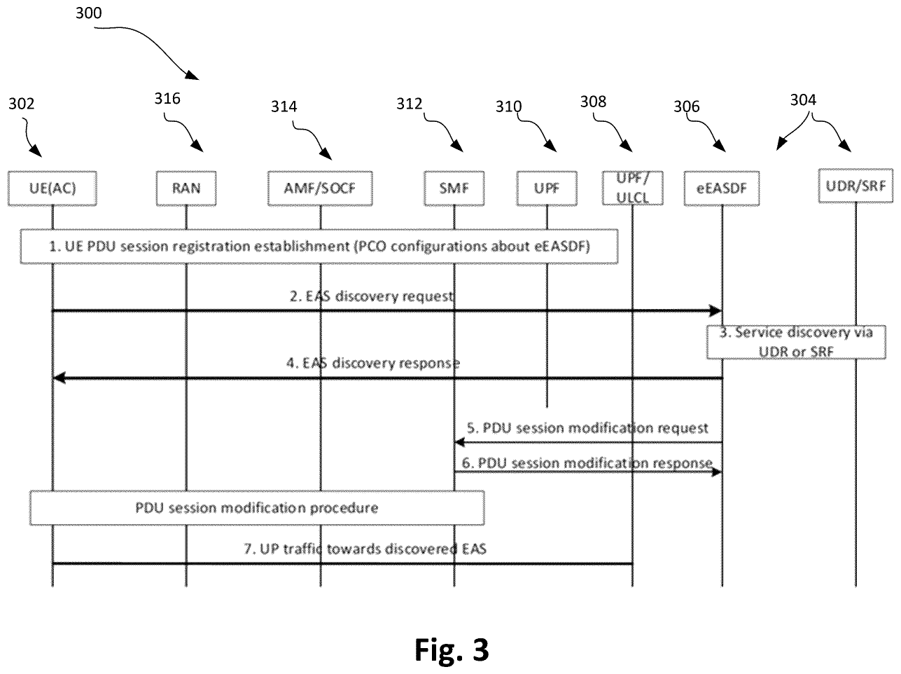

FIG. 3 shows a sequence diagram 300 illustrating end-to-end service discovery and user-plane steering toward a selected edge application server according to some embodiments.

Per elements 1 through 7 of FIG. 3, the UE(AC) 302 exchanges signaling via the RAN 316 toward AMF/SOCF 314 and SMF 312, discovery requests traverse the user plane via UPF 310 and, where deployed, ULCL 308 to reach eEASDF 306, and eEASDF 306 interacts with UDR/SRF 304 to resolve candidates and coordinate PDU session modification for traffic steering to the selected edge instance.

Per element 1 of FIG. 3, the UE(AC) 302 performs PDU session registration and establishment, with the RAN 316 relaying NAS signaling transparently to AMF/SOCF 314. During this procedure, the UE(AC) 302 requests PCO configurations related to eEASDF 306. AMF/SOCF 314, in coordination with SMF 312, provides PCO values including discovery protocol indicators, eEASDF endpoints, and filter template identifiers, and configures UPF 310 and ULCL 308 so that discovery traffic associated with designated selectors is forwarded toward eEASDF 306. The eEASDF 306 itself can be selected via the NRF consistent with baseline discovery function selection. UE registration and PDU session establishment in general can follow TS 23.502 Section 4.3.2, with the specifics however of embodiments as introduced herein. In the UE's PDU session establishment request sent to the AMF, the UE requests PCO for filter-based service discovery with eEASDF (instead of DNS as set out in Section 5.1.1); the AMF returns PCO including the Section 5.1.1 information; the SMF configures the UPF to forward discovery traffic to eEASDF; and eEASDF selection/discovery can be based on NRF.

Per element 2 of FIG. 3, after the session is established, the UE(AC) 302 sends an edge application server discovery request over the user plane to eEASDF 306 in accordance with the PCO-delivered schema. The request may include filters identifying EASID, version, location scope, workload characteristics, QoS objectives, DNN, and S-NSSAI, as well as service continuity preferences and instantiation status, enabling fine-grained matching.

Per element 3 of FIG. 3, eEASDF 306 queries UDR/SRF 304 to retrieve candidate edge application servers that satisfy the UE's filters. Repository queries may evaluate spatial validity, freshness of telemetry, and KPI thresholds so that candidates reflect current performance and availability, and may apply federation or roaming constraints where applicable.

Per element 4 of FIG. 3, eEASDF 306 returns a discovery response to UE(AC) 302 that includes one or more candidates, a recommended selection, and optional validity information (for example, DNAI scope and time-to-live). Where name resolution is required, the response can include FQDN mappings aligned with the selected candidate to facilitate subsequent steering. Policies (for example, configured by PCF) may be applied to refine the candidate list and to select an appropriate EAS instance.

Per elements 5 and 6 of FIG. 3, based on the selected candidate, eEASDF 306 triggers SMF 312 to perform a PDU session modification procedure to add or delete ULCL rules at 308 and/or reselect or reconfigure UPF 310. The modification request includes the cause, location context, QoS and slice information, and any applicable DNAI preferences. AMF/SOCF 314 notifies UE(AC) 302 of the modification outcome, while SMF 312 confirms whether the requested changes were approved or successfully applied. The request for modification may include information related to ULCL updates or UPF reselection (including location, QoS, DNN, and S-NSSAI). In preferred embodiments, modifying an existing session is favored over creating a new session to minimize reconfiguration latency; during the transition, eEASDF 306 may temporarily buffer or suppress DNS responses linked to the selection until user-plane updates complete to avoid misrouting.

Per element 7 of FIG. 3, UE(AC) 302 sends subsequent user-plane traffic toward the selected edge application server using the modified session, with UPF 310 and ULCL 308 classifying and steering flows according to updated rules. Route selection policies administered by the SOCF portion of 314 may direct application-specific traffic to the updated anchor, and rediscovery can be initiated by eEASDF 306 upon mobility events or KPI drift to maintain service performance.

### Systems and Implementations

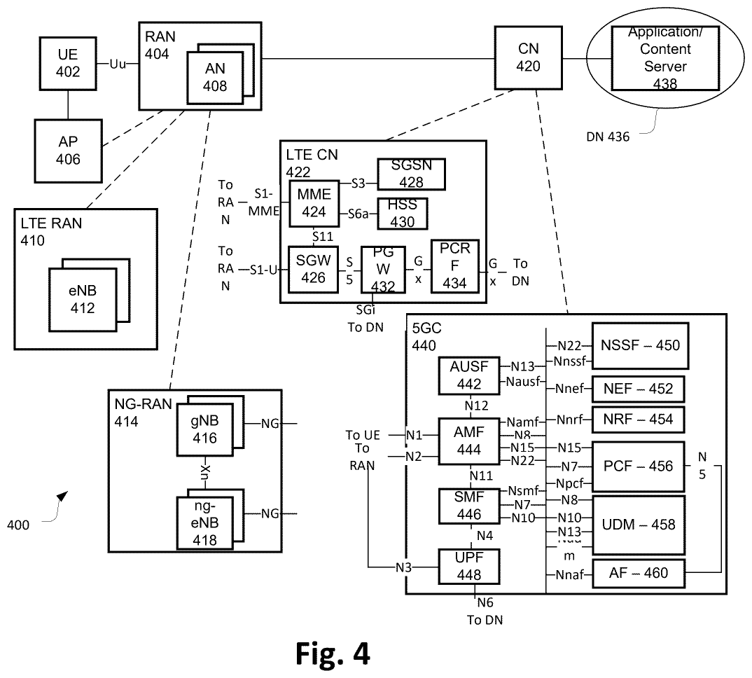

FIGS. 4-10 illustrate various systems, devices, and components that may implement aspects of disclosed embodiments.

FIG. 4 illustrates a network 400 in accordance with various embodiments. The network 400 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 400 may include a UE 402, which may include any mobile or non-mobile computing device designed to communicate with a RAN 404 via an over-the-air connection. The UE 402 may be communicatively coupled with the RAN 404 by a Uu interface. The UE 402 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 400 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 402 may additionally communicate with an AP 406 via an over-the-air connection. The AP 406 may manage a WLAN connection, which may serve to offload some/all network traffic from the RAN 404. The connection between the UE 402 and the AP 406 may be consistent with any IEEE 802.11 protocol, wherein the AP 406 could be a wireless fidelity (Wi-Fi®) router. In some embodiments, the UE 402, RAN 404, and AP 406 may utilize cellular-WLAN aggregation (for example, LWA/LWIP). Cellular-WLAN aggregation may involve the UE 402 being configured by the RAN 404 to utilize both cellular radio resources and WLAN resources.

The RAN 404 may include one or more access nodes, for example, AN 408. AN 408 may terminate air-interface protocols for the UE 402 by providing access stratum protocols including RRC, PDCP, RLC, MAC, and L1 protocols. In this manner, the AN 408 may enable data/voice connectivity between CN 420 and the UE 402. In some embodiments, the AN 408 may be implemented in a discrete device or as one or more software entities running on server computers as part of, for example, a virtual network, which may be referred to as a CRAN or virtual baseband unit pool. The AN 408 be referred to as a BS, gNB, RAN node, eNB, ng-eNB, NodeB, RSU, TRxP, TRP, etc. The AN 408 may be a macrocell base station or a low power base station for providing femtocells, picocells or other like cells having smaller coverage areas, smaller user capacity, or higher bandwidth compared to macrocells.

In embodiments in which the RAN 404 includes a plurality of ANs, they may be coupled with one another via an X2 interface (if the RAN 404 is an LTE RAN) or an Xn interface (if the RAN 404 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 404 may each manage one or more cells, cell groups, component carriers, etc. to provide the UE 402 with an air interface for network access. The UE 402 may be simultaneously connected with a plurality of cells provided by the same or different ANs of the RAN 404. For example, the UE 402 and RAN 404 may use carrier aggregation to allow the UE 402 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 404 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 402 or AN 408 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 404 may be an LTE RAN 410 with eNBs, for example, eNB 412. The LTE RAN 410 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 404 may be an NG-RAN 414 with gNBs, for example, gNB 416, or ng-eNBs, for example, ng-eNB 418. The gNB 416 may connect with 5G-enabled UEs using a 5G NR interface. The gNB 416 may connect with a 5G core through an NG interface, which may include an N2 interface or an N3 interface. The ng-eNB 418 may also connect with the 5G core through an NG interface, but may connect with a UE via an LTE air interface. The gNB 416 and the ng-eNB 418 may connect with each other over an Xn interface.

In some embodiments, the NG interface may be split into two parts, an NG user plane (NG-U) interface, which carries traffic data between the nodes of the NG-RAN 414 and a UPF 448 (e.g., N3 interface), and an NG control plane (NG-C) interface, which is a signaling interface between the nodes of the NG-RAN414 and an AMF 444 (e.g., N2 interface).

The NG-RAN 414 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 402 can be configured with multiple BWPs where each BWP configuration has a different SCS. When a BWP change is indicated to the UE 402, the SCS of the transmission is changed as well. Another use case example of BWP is related to power saving. In particular, multiple BWPs can be configured for the UE 402 with different amount of frequency resources (for example, PRBs) to support data transmission under different traffic loading scenarios. A BWP containing a smaller number of PRBs can be used for data transmission with small traffic load while allowing power saving at the UE 402 and in some cases at the gNB 416. A BWP containing a larger number of PRBs can be used for scenarios with higher traffic load.

The RAN 404 is communicatively coupled to CN 420 that includes network elements to provide various functions to support data and telecommunications services to customers/subscribers (for example, users of UE 402). The components of the CN 420 may be implemented in one physical node or separate physical nodes. In some embodiments, NFV may be utilized to virtualize any or all of the functions provided by the network elements of the CN 420 onto physical compute/storage resources in servers, switches, etc. A logical instantiation of the CN 420 may be referred to as a network slice, and a logical instantiation of a portion of the CN 420 may be referred to as a network sub-slice.

In some embodiments, the CN 420 may be an LTE CN 422, which may also be referred to as an EPC. The LTE CN 422 may include MME 424, SGW 426, SGSN 428, HSS 430, PGW 432, and PCRF 434 coupled with one another over interfaces (or “reference points”) as shown. Functions of the elements of the LTE CN 422 may be briefly introduced as follows.

The MME 424 may implement mobility management functions to track a current location of the UE 402 to facilitate paging, bearer activation/deactivation, handovers, gateway selection, authentication, etc.

The SGW 426 may terminate an S1 interface toward the RAN and route data packets between the RAN and the LTE CN 422. The SGW 426 may be a local mobility anchor point for inter-RAN node handovers and also may provide an anchor for inter-3GPP mobility. Other responsibilities may include lawful intercept, charging, and some policy enforcement.

The SGSN 428 may track a location of the UE 402 and perform security functions and access control. In addition, the SGSN 428 may perform inter-EPC node signaling for mobility between different RAT networks; PDN and S-GW selection as specified by MME 424; MME selection for handovers; etc. The S3 reference point between the MME 424 and the SGSN 428 may enable user and bearer information exchange for inter-3GPP access network mobility in idle/active states.

The HSS 430 may include a database for network users, including subscription-related information to support the network entities' handling of communication sessions. The HSS 430 can provide support for routing/roaming, authentication, authorization, naming/addressing resolution, location dependencies, etc. An S6a reference point between the HSS 430 and the MME 424 may enable transfer of subscription and authentication data for authenticating/authorizing user access to the LTE CN 420.

The PGW 432 may terminate an SGi interface toward a data network (DN) 436 that may include an application/content server 438. The PGW 432 may route data packets between the LTE CN 422 and the data network 436. The PGW 432 may be coupled with the SGW 426 by an S5 reference point to facilitate user plane tunneling and tunnel management. The PGW 432 may further include a node for policy enforcement and charging data collection (for example, PCEF). Additionally, the SGi reference point between the PGW 432 and the data network QX 36 may be an operator external public, a private PDN, or an intra-operator packet data network, for example, for provision of IMS services. The PGW 432 may be coupled with a PCRF 434 via a Gx reference point.

The PCRF 434 is the policy and charging control element of the LTE CN 422. The PCRF 434 may be communicatively coupled to the app/content server 438 to determine appropriate QoS and charging parameters for service flows. The PCRF 432 may provision associated rules into a PCEF (via Gx reference point) with appropriate TFT and QCI.

In some embodiments, the CN 420 may be a 5GC 440. The 5GC 440 may include an AUSF 442, AMF 444, SMF 446, UPF 448, NSSF 450, NEF 452, NRF 454, PCF 456, UDM 458, and AF 460 coupled with one another over interfaces (or “reference points”) as shown. Functions of the elements of the 5GC 440 may be briefly introduced as follows.

The AUSF 442 may store data for authentication of UE 402 and handle authentication-related functionality. The AUSF 442 may facilitate a common authentication framework for various access types. In addition to communicating with other elements of the 5GC 440 over reference points as shown, the AUSF 442 may exhibit an Nausf service-based interface.

The AMF 444 may allow other functions of the 5GC 440 to communicate with the UE 402 and the RAN 404 and to subscribe to notifications about mobility events with respect to the UE 402. The AMF 444 may be responsible for registration management (for example, for registering UE 402), connection management, reachability management, mobility management, lawful interception of AMF-related events, and access authentication and authorization. The AMF 444 may provide transport for SM messages between the UE 402 and the SMF 446, and act as a transparent proxy for routing SM messages. AMF 444 may also provide transport for SMS messages between UE 402 and an SMSF. AMF 444 may interact with the AUSF 442 and the UE 402 to perform various security anchor and context management functions. Furthermore, AMF 444 may be a termination point of a RAN CP interface, which may include or be an N2 reference point between the RAN 404 and the AMF 444; and the AMF 444 may be a termination point of NAS (N1) signaling, and perform NAS ciphering and integrity protection. AMF 444 may also support NAS signaling with the UE 402 over an N3 IWF interface.

The SMF 446 may be responsible for SM (for example, session establishment, tunnel management between UPF 448 and AN 408); UE IP address allocation and management (including optional authorization); selection and control of UP function; configuring traffic steering at UPF 448 to route traffic to proper destination; termination of interfaces toward policy control functions; controlling part of policy enforcement, charging, and QoS; lawful intercept (for SM events and interface to L1 system); termination of SM parts of NAS messages; downlink data notification; initiating AN specific SM information, sent via AMF 444 over N2 to AN 408; and determining SSC mode of a session. SM may refer to management of a PDU session, and a PDU session or “session” may refer to a PDU connectivity service that provides or enables the exchange of PDUs between the UE 402 and the data network 436.

The UPF 448 may act as an anchor point for intra-RAT and inter-RAT mobility, an external PDU session point of interconnect to data network 436, and a branching point to support multi-homed PDU session. The UPF 448 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 448 may include an uplink classifier to support routing traffic flows to a data network.

The NSSF 450 may select a set of network slice instances serving the UE 402. The NSSF 450 may also determine allowed NSSAI and the mapping to the subscribed S-NSSAIs, if needed. The NSSF 450 may also determine the AMF set to be used to serve the UE 402, or a list of candidate AMFs based on a suitable configuration and possibly by querying the NRF 454. The selection of a set of network slice instances for the UE 402 may be triggered by the AMF 444 with which the UE 402 is registered by interacting with the NSSF 450, which may lead to a change of AMF. The NSSF 450 may interact with the AMF 444 via an N22 reference point; and may communicate with another NSSF in a visited network via an N31 reference point (not shown). Additionally, the NSSF 450 may exhibit an Nnssf service-based interface.

The NEF 452 may securely expose services and capabilities provided by 3GPP network functions for third party, internal exposure/re-exposure, AFs (e.g., AF 460), edge computing or fog computing systems, etc. In such embodiments, the NEF 452 may authenticate, authorize, or throttle the AFs. NEF 452 may also translate information exchanged with the AF 460 and information exchanged with internal network functions. For example, the NEF 452 may translate between an AF-Service-Identifier and an internal 5GC information. NEF 452 may also receive information from other NFs based on exposed capabilities of other NFs. This information may be stored at the NEF 452 as structured data, or at a data storage NF using standardized interfaces. The stored information can then be re-exposed by the NEF 452 to other NFs and AFs, or used for other purposes such as analytics. Additionally, the NEF 452 may exhibit an Nnef service-based interface.

The NRF 454 may support service discovery functions, receive NF discovery requests from NF instances, and provide the information of the discovered NF instances to the NF instances. NRF 454 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 454 may exhibit the Nnrf service-based interface.

The PCF 456 may provide policy rules to control plane functions to enforce them, and may also support unified policy framework to govern network behavior. The PCF 456 may also implement a front end to access subscription information relevant for policy decisions in a UDR of the UDM 458. In addition to communicating with functions over reference points as shown, the PCF 456 exhibit an Npcf service-based interface.

The UDM 458 may handle subscription-related information to support the network entities' handling of communication sessions, and may store subscription data of UE 402. For example, subscription data may be communicated via an N8 reference point between the UDM 458 and the AMF 444. The UDM 458 may include two parts, an application front end and a UDR. The UDR may store subscription data and policy data for the UDM 458 and the PCF 456, and/or structured data for exposure and application data (including PFDs for application detection, application request information for multiple UEs 402) for the NEF 452. The Nudr service-based interface may be exhibited by the UDR 221 to allow the UDM 458, PCF 456, and NEF 452 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 458 may exhibit the Nudm service-based interface.

The AF 460 may provide application influence on traffic routing, provide access to NEF, and interact with the policy framework for policy control.

In some embodiments, the 5GC 440 may enable edge computing by selecting operator/3rd party services to be geographically close to a point that the UE 402 is attached to the network. This may reduce latency and load on the network. To provide edge-computing implementations, the 5GC 440 may select a UPF 448 close to the UE 402 and execute traffic steering from the UPF 448 to data network 436 via the N6 interface. This may be based on the UE subscription data, UE location, and information provided by the AF 460. In this way, the AF 460 may influence UPF (re) selection and traffic routing. Based on operator deployment, when AF 460 is considered to be a trusted entity, the network operator may permit AF 460 to interact directly with relevant NFs. Additionally, the AF 460 may exhibit an Naf service-based interface.

The data network 436 may represent various network operator services, Internet access, or third party services that may be provided by one or more servers including, for example, application/content server 438.

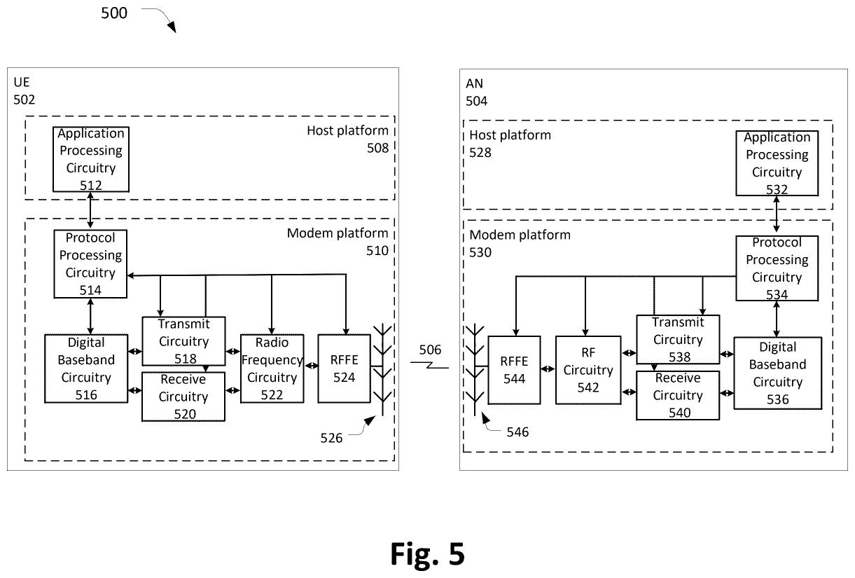

FIG. 5 schematically illustrates a wireless network 500 in accordance with various embodiments. The wireless network 500 may include a UE 502 in wireless communication with an AN 504. The UE 502 and AN 504 may be similar to, and substantially interchangeable with, like-named components described elsewhere herein.

The UE 502 may be communicatively coupled with the AN 504 via connection 506. The connection 506 is illustrated as an air interface to enable communicative coupling, and can be consistent with cellular communications protocols such as an LTE protocol or a 5G NR protocol operating at mm Wave or sub-6 GHZ frequencies.

The UE 502 may include a host platform 508 coupled with a modem platform 510. The host platform 508 may include application processing circuitry 512, which may be coupled with protocol processing circuitry 514 of the modem platform 510. The application processing circuitry 512 may run various applications for the UE 502 that source/sink application data. The application processing circuitry 512 may further implement one or more layer operations to transmit/receive application data to/from a data network. These layer operations may include transport (for example UDP) and Internet (for example, IP) operations

The protocol processing circuitry 514 may implement one or more of layer operations to facilitate transmission or reception of data over the connection 506. The layer operations implemented by the protocol processing circuitry 514 may include, for example, MAC, RLC, PDCP, RRC and NAS operations.

The modem platform 510 may further include digital baseband circuitry 516 that may implement one or more layer operations that are “below” layer operations performed by the protocol processing circuitry 514 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 510 may further include transmit circuitry 518, receive circuitry 520, RF circuitry 522, and RF front end (RFFE) 524, which may include or connect to one or more antenna panels 526. Briefly, the transmit circuitry 518 may include a digital-to-analog converter, mixer, intermediate frequency (IF) components, etc.; the receive circuitry 520 may include an analog-to-digital converter, mixer, IF components, etc.; the RF circuitry 522 may include a low-noise amplifier, a power amplifier, power tracking components, etc.; RFFE 524 may include filters (for example, surface/bulk acoustic wave filters), switches, antenna tuners, beamforming components (for example, phase-array antenna components), etc. The selection and arrangement of the components of the transmit circuitry 518, receive circuitry 520, RF circuitry 522, RFFE 524, and antenna panels 526 (referred generically as “transmit/receive components”) may be specific to details of a specific implementation such as, for example, whether communication is TDM or FDM, in mm Wave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 514 may include one or more instances of control circuitry (not shown) to provide control functions for the transmit/receive components.

A UE reception may be established by and via the antenna panels 526, RFFE 524, RF circuitry 522, receive circuitry 520, digital baseband circuitry 516, and protocol processing circuitry 514. In some embodiments, the antenna panels 526 may receive a transmission from the AN 504 by receive-beamforming signals received by a plurality of antennas/antenna elements of the one or more antenna panels 526.

A UE transmission may be established by and via the protocol processing circuitry 514, digital baseband circuitry 516, transmit circuitry 518, RF circuitry 522, RFFE 524, and antenna panels 526. In some embodiments, the transmit components of the UE 504 may apply a spatial filter to the data to be transmitted to form a transmit beam emitted by the antenna elements of the antenna panels 526.

Similar to the UE 502, the AN 504 may include a host platform 528 coupled with a modem platform 530. The host platform 528 may include application processing circuitry 532 coupled with protocol processing circuitry 534 of the modem platform 530. The modem platform may further include digital baseband circuitry 536, transmit circuitry 538, receive circuitry 540, RF circuitry 542, RFFE circuitry 544, and antenna panels 546. The components of the AN 504 may be similar to and substantially interchangeable with like-named components of the UE 502. In addition to performing data transmission/reception as described above, the components of the AN 508 may perform various logical functions that include, for example, RNC functions such as radio bearer management, uplink and downlink dynamic radio resource management, and data packet scheduling.

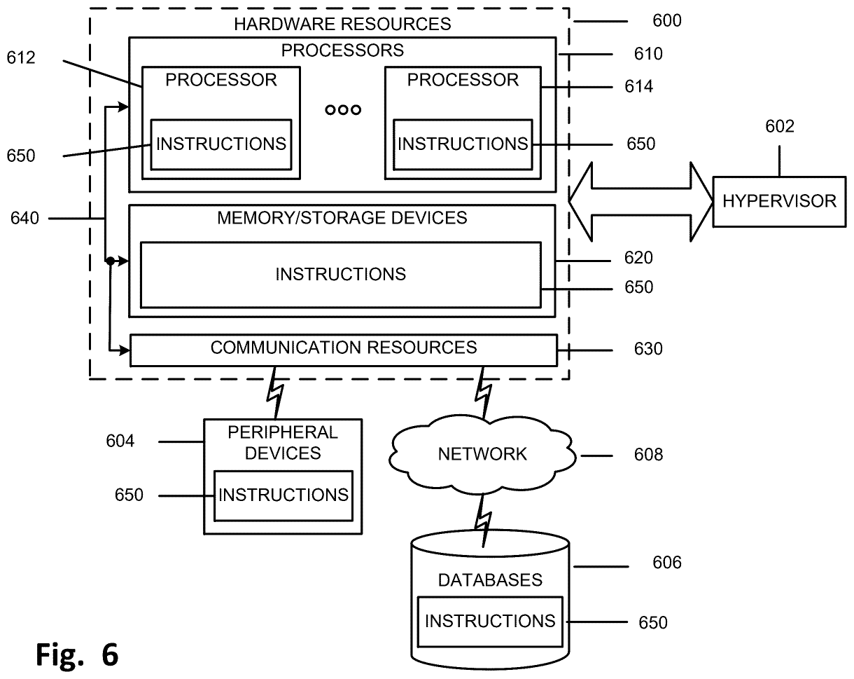

FIG. 6 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 6 shows a diagrammatic representation of hardware resources 600 including one or more processors (or processor cores) 610, one or more memory/storage devices 620, and one or more communication resources 630, each of which may be communicatively coupled via a bus 640 or other interface circuitry. For embodiments where node virtualization (e.g., NFV) is utilized, a hypervisor 602 may be executed to provide an execution environment for one or more network slices/sub-slices to utilize the hardware resources 600.

The processors 610 may include, for example, a processor 612 and a processor 614. The processors 610 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 620 may include main memory, disk storage, or any suitable combination thereof. The memory/storage devices 620 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 630 may include interconnection or network interface controllers, components, or other suitable devices to communicate with one or more peripheral devices 604 or one or more databases 606 or other network elements via a network 608. For example, the communication resources 630 may include wired communication components (e.g., for coupling via USB, Ethernet, etc.), cellular communication components, NFC components, Bluetooth® (or Bluetooth® Low Energy) components, Wi-Fi® components, and other communication components.

Instructions 650 may comprise software, a program, an application, an applet, an app, or other executable code for causing at least any of the processors 610 to perform any one or more of the methodologies discussed herein. The instructions 650 may reside, completely or partially, within at least one of the processors 610 (e.g., within the processor's cache memory), the memory/storage devices 620, or any suitable combination thereof. Furthermore, any portion of the instructions 650 may be transferred to the hardware resources 600 from any combination of the peripheral devices 604 or the databases 606. Accordingly, the memory of processors 610, the memory/storage devices 620, the peripheral devices 604, and the databases 606 are examples of computer-readable and machine-readable media.

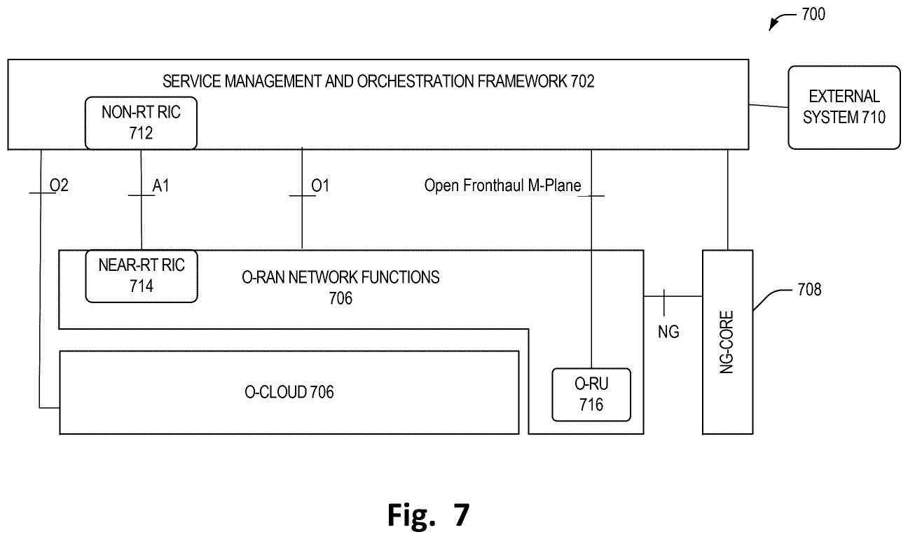

FIG. 7 provides a high-level view of an Open RAN (O-RAN) architecture 700. The O-RAN architecture 700 includes four O-RAN defined interfaces—namely, the A1 interface, the O1 interface, the O2 interface, and the Open Fronthaul Management (M)-plane interface—which connect the Service Management and Orchestration (SMO) framework 702 to O-RAN network functions (NFs) 704 and the O-Cloud 706. The SMO 702 (described in [O13]) also connects with an external system 710, which provides enrichment data to the SMO 702. FIG. 7 also illustrates that the A1 interface terminates at an O-RAN Non-Real Time (RT) RAN Intelligent Controller (RIC) 712 in or at the SMO 702 and at the O-RAN Near-RT RIC 714 in or at the O-RAN NFS 704. The O-RAN NFs 704 can be VNFs such as VMs or containers, sitting above the O-Cloud 706 and/or Physical Network Functions (PNFs) utilizing customized hardware. All O-RAN NFs 704 are expected to support the O1 interface when interfacing the SMO framework 702. The O-RAN NFs 704 connect to the NG-Core 708 via the NG interface (which is a 3GPP defined interface). The Open Fronthaul M-plane interface between the SMO 702 and the O-RAN Radio Unit (O-RU) 716 supports the O-RU 716 management in the O-RAN hybrid model as specified in [O16]. The Open Fronthaul M-plane interface is an optional interface to the SMO 702 that is included for backward compatibility purposes as per [O16], and is intended for management of the O-RU 716 in hybrid mode only. The management architecture of flat mode and its relation to the O1 interface for the O-RU 716 is for future study. The O-RU 716 termination of the O1 interface towards the SMO 702 as specified in [O12].

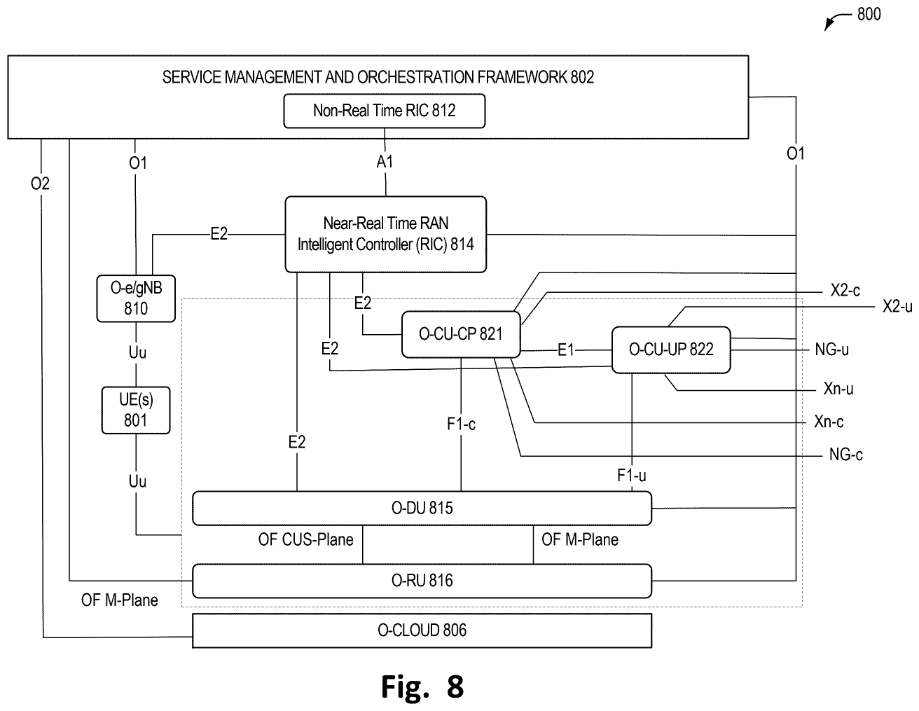

FIG. 8 shows an O-RAN logical architecture 800 corresponding to the O-RAN architecture 700 of FIG. 7. In FIG. 8, the SMO 802 corresponds to the SMO 702, O-Cloud 806 corresponds to the O-Cloud 706, the non-RT RIC 812 corresponds to the non-RT RIC 712, the near-RT RIC 814 corresponds to the near-RT RIC 714, and the O-RU 816 corresponds to the O-RU 716 of FIG. 8, respectively. The O-RAN logical architecture 800 includes a radio portion and a management portion.

The management portion/side of the architectures 800 includes the SMO Framework 802 containing the non-RT RIC 812, and may include the O-Cloud 806. The O-Cloud 806 is a cloud computing platform including a collection of physical infrastructure nodes to host the relevant O-RAN functions (e.g., the near-RT RIC 814, O-CU-CP 821, O-CU-UP 822, and the O-DU 815), supporting software components (e.g., OSs, VMMs, container runtime engines, ML engines, etc.), and appropriate management and orchestration functions.

The radio portion/side of the logical architecture 800 includes the near-RT RIC 814, the O-RAN Distributed Unit (O-DU) 815, the O-RU 816, the O-RAN Central Unit-Control Plane (O-CU-CP) 821, and the O-RAN Central Unit-User Plane (O-CU-UP) 822 functions. The radio portion/side of the logical architecture 800 may also include the O-e/gNB 810.

The O-DU 815 is a logical node hosting RLC, MAC, and higher PHY layer entities/elements (High-PHY layers) based on a lower layer functional split. The O-RU 816 is a logical node hosting lower PHY layer entities/elements (Low-PHY layer) (e.g., FFT/iFFT, PRACH extraction, etc.) and RF processing elements based on a lower layer functional split. Virtualization of O-RU 816 is FFS. The O-CU-CP 821 is a logical node hosting the RRC and the control plane (CP) part of the PDCP protocol. The O O-CU-UP 822 is a logical node hosting the user plane part of the PDCP protocol and the SDAP protocol.

An E2 interface terminates at a plurality of E2 nodes. The E2 nodes are logical nodes/entities that terminate the E2 interface. For NR/5G access, the E2 nodes include the O-CU-CP 821, O-CU-UP 822, O-DU 815, or any combination of elements as defined in [O15]. For E-UTRA access the E2 nodes include the O-e/gNB 810. As shown in FIG. 8, the E2 interface also connects the O-e/gNB 810 to the Near-RT RIC 814. The protocols over E2 interface are based exclusively on Control Plane (CP) protocols. The E2 functions are grouped into the following categories: (a) near-RT RIC 814 services (REPORT, INSERT, CONTROL and POLICY, as described in [O15]); and (b) near-RT RIC 814 support functions, which include E2 Interface Management (E2 Setup, E2 Reset, Reporting of General Error Situations, etc.) and Near-RT RIC Service Update (e.g., capability exchange related to the list of E2 Node functions exposed over E2).

FIG. 8 shows the Uu interface between a UE 801 and O-e/gNB 810 as well as between the UE 801 and O-RAN components. The Uu interface is a 3GPP defined interface (see e.g., sections 5.2 and 5.3 of [O07]), which includes a complete protocol stack from L1 to L3 and terminates in the NG-RAN or E-UTRAN. The O-e/gNB 810 is an LTE eNB [O04], a 5G gNB or ng-eNB [O16] that supports the E2 interface. The O-e/gNB 810 may be the same or similar as eNB 412, gNB 416, ng-eNB 418, RAN 908, RAN ZZY10, or some other base station, RAN, or nodeB discussed previously. The a UE 801 may correspond to UEs 402, 502, 902, UE ZZY05, or some other UE discussed with respect to other Figures herein, and/or the like. There may be multiple UEs 801 and/or multiple O-e/gNB 810, each of which may be connected to one another the via respective Uu interfaces. Although not shown in FIG. 8, the O-e/gNB 810 supports O-DU 815 and O-RU 816 functions with an Open Fronthaul interface between them.

The Open Fronthaul (OF) interface(s) is/are between O-DU 815 and O-RU 816 functions [O16][O17]. The OF interface(s) includes the Control User Synchronization (CUS) Plane and Management (M) Plane. FIGS. 7 and 8 also show that the O-RU 816 terminates the OF M-Plane interface towards the O-DU 815 and optionally towards the SMO 802 as specified in [O16]. The O-RU 816 terminates the OF CUS-Plane interface towards the O-DU 815 and the SMO 802.

The F1-c interface connects the O-CU-CP 821 with the O-DU 815. As defined by 3GPP, the F1-c interface is between the gNB-CU-CP and gNB-DU nodes [O07] [O10]. However, for purposes of O-RAN, the F1-c interface is adopted between the O-CU-CP 821 with the O-DU 815 functions while reusing the principles and protocol stack defined by 3GPP and the definition of interoperability profile specifications.

The F1-u interface connects the O-CU-UP 822 with the O-DU 815. As defined by 3GPP, the F1-u interface is between the gNB-CU-UP and gNB-DU nodes [O07] [O10]. However, for purposes of O-RAN, the F1-u interface is adopted between the O-CU-UP 822 with the O-DU 815 functions while reusing the principles and protocol stack defined by 3GPP and the definition of interoperability profile specifications.

The NG-c interface is defined by 3GPP as an interface between the gNB-CU-CP and the AMF in the 5GC [O06]. The NG-c is also referred as the N2 interface (see [O06]). The NG-u interface is defined by 3GPP, as an interface between the gNB-CU-UP and the UPF in the 5GC [O06]. The NG-u interface is referred as the N3 interface (see [O06]). In O-RAN, NG-c and NG-u protocol stacks defined by 3GPP are reused and may be adapted for O-RAN purposes.

The X2-c interface is defined in 3GPP for transmitting control plane information between eNBs or between eNB and en-gNB in EN-DC. The X2-u interface is defined in 3GPP for transmitting user plane information between eNBs or between eNB and en-gNB in EN-DC (see e.g., [O05], [O06]). In O-RAN, X2-c and X2-u protocol stacks defined by 3GPP are reused and may be adapted for O-RAN purposes

The Xn-c interface is defined in 3GPP for transmitting control plane information between gNBs, ng-eNBs, or between an ng-eNB and gNB. The Xn-u interface is defined in 3GPP for transmitting user plane information between gNBs, ng-eNBs, or between ng-eNB and gNB (see e.g., [O06], [O08]). In O-RAN, Xn-c and Xn-u protocol stacks defined by 3GPP are reused and may be adapted for O-RAN purposes

The E1 interface is defined by 3GPP as being an interface between the gNB-CU-CP (e.g., gNB-CU-CP 3728) and gNB-CU-UP (see e.g., [O07], [O09]). In O-RAN, E1 protocol stacks defined by 3GPP are reused and adapted as being an interface between the O-CU-CP 821 and the O-CU-UP 822 functions.

The O-RAN Non-Real Time (RT) RAN Intelligent Controller (RIC) 812 is a logical function within the SMO framework 702, 802 that enables non-real-time control and optimization of RAN elements and resources; AI/machine learning (ML) workflow(s) including model training, inferences, and updates; and policy-based guidance of applications/features in the Near-RT RIC 814.

The O-RAN near-RT RIC 814 is a logical function that enables near-real-time control and optimization of RAN elements and resources via fine-grained data collection and actions over the E2 interface. The near-RT RIC 814 may include one or more AI/ML workflows including model training, inferences, and updates.

The non-RT RIC 812 can be an ML training host to host the training of one or more ML models. ML training can be performed offline using data collected from the RIC, O-DU 815 and O-RU 816. For supervised learning, non-RT RIC 812 is part of the SMO 802, and the ML training host and/or ML model host/actor can be part of the non-RT RIC 812 and/or the near-RT RIC 814. For unsupervised learning, the ML training host and ML model host/actor can be part of the non-RT RIC 812 and/or the near-RT RIC 814. For reinforcement learning, the ML training host and ML model host/actor may be co-located as part of the non-RT RIC 812 and/or the near-RT RIC 814. In some implementations, the non-RT RIC 812 may request or trigger ML model training in the training hosts regardless of where the model is deployed and executed. ML models may be trained and not currently deployed.

In some implementations, the non-RT RIC 812 provides a query-able catalog for an ML designer/developer to publish/install trained ML models (e.g., executable software components). In these implementations, the non-RT RIC 812 may provide discovery mechanism if a particular ML model can be executed in a target ML inference host (MF), and what number and type of ML models can be executed in the MF. For example, there may be three types of ML catalogs made discoverable by the non-RT RIC 812: a design-time catalog (e.g., residing outside the non-RT RIC 812 and hosted by some other ML platform(s)), a training/deployment-time catalog (e.g., residing inside the non-RT RIC 812), and a run-time catalog (e.g., residing inside the non-RT RIC 812). The non-RT RIC 812 supports necessary capabilities for ML model inference in support of ML assisted solutions running in the non-RT RIC 812 or some other ML inference host. These capabilities enable executable software to be installed such as VMs, containers, etc. The non-RT RIC 812 may also include and/or operate one or more ML engines, which are packaged software executable libraries that provide methods, routines, data types, etc., used to run ML models. The non-RT RIC 812 may also implement policies to switch and activate ML model instances under different operating conditions.

The non-RT RIC 82 is be able to access feedback data (e.g., FM and PM statistics) over the O1 interface on ML model performance and perform necessary evaluations. If the ML model fails during runtime, an alarm can be generated as feedback to the non-RT RIC 812. How well the ML model is performing in terms of prediction accuracy or other operating statistics it produces can also be sent to the non-RT RIC 812 over O1. The non-RT RIC 812 can also scale ML model instances running in a target MF over the O1 interface by observing resource utilization in MF. The environment where the ML model instance is running (e.g., the MF) monitors resource utilization of the running ML model. This can be done, for example, using an ORAN-SC component called Resource Monitor in the near-RT RIC 814 and/or in the non-RT RIC 812, which continuously monitors resource utilization. If resources are low or fall below a certain threshold, the runtime environment in the near-RT RIC 814 and/or the non-RT RIC 812 provides a scaling mechanism to add more ML instances. The scaling mechanism may include a scaling factor such as an number, percentage, and/or other like data used to scale up/down the number of ML instances. ML model instances running in the target ML inference hosts may be automatically scaled by observing resource utilization in the MF. For example, the Kubernetes® (K8s) runtime environment typically provides an auto-scaling feature.

The A1 interface is between the non-RT RIC 812 (within or outside the SMO 802) and the near-RT RIC 814. The A1 interface supports three types of services as defined in [O14], including a Policy Management Service, an Enrichment Information Service, and ML Model Management Service. A1 policies have the following characteristics compared to persistent configuration [O14]: A1 policies are not critical to traffic; A1 policies have temporary validity; A1 policies may handle individual UE or dynamically defined groups of UEs; A1 policies act within and take precedence over the configuration; and A1 policies are non-persistent, i.e., do not survive a restart of the near-RT RIC.

References that are relevant to the above description include the following:
[O04] 3GPP TS 36.401 v15.1.0 (2019-01-09).
[O05] 3GPP TS 36.420 v15.2.0 (2020-01-09).
[O06] 3GPP TS 38.300 v16.0.0 (2020-01-08).
[O07] 3GPP TS 38.401 v16.0.0 (2020-01-09).
[O08] 3GPP TS 38.420 v15.2.0 (2019-01-08).
[O09] 3GPP TS 38.460 v16.0.0 (2020-01-09).
[O10] 3GPP TS 38.470 v16.0.0 (2020-01-09).
[O12] O-RAN Alliance Working Group 1, O-RAN Operations and Maintenance Architecture Specification, version 2.0 (December 2019) (“O-RAN-WG1.OAM-Architecture-v02.00”).
[O13] O-RAN Alliance Working Group 1, O-RAN Operations and Maintenance Interface Specification, version 2.0 (December 2019) (“O-RAN-WG1.01-Interface-v02.00”).
[O14] O-RAN Alliance Working Group 2, O-RAN A1 interface: General Aspects and Principles Specification, version 1.0 (October 2019) (“ORAN-WG2.A1.GA&P-v01.00”).
[O15] O-RAN Alliance Working Group 3, Near-Real-time RAN Intelligent Controller Architecture & E2 General Aspects and Principles (“ORAN-WG3.E2GAP.0-v0.1”).
[O16] O-RAN Alliance Working Group 4, O-RAN Fronthaul Management Plane Specification, version 2.0 (July 2019) (“ORAN-WG4.MP.0-v02.00.00”).
[O17]O-RAN Alliance Working Group 4, O-RAN Fronthaul Control, User and Synchronization Plane Specification, version 2.0 (July 2019) (“ORAN-WG4.CUS.0-v02.00”).

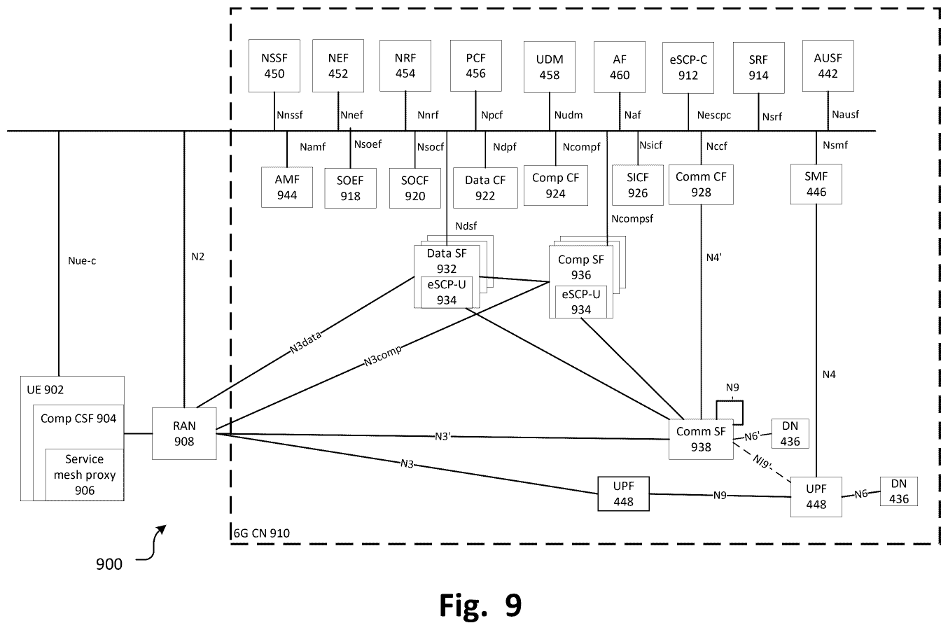

FIG. 9 illustrates a network 900 in accordance with various embodiments. The network 900 may operate in a matter consistent with 3GPP technical specifications or technical reports for 6G systems. In some embodiments, the network 900 may operate concurrently with network 400. For example, in some embodiments, the network 900 may share one or more frequency or bandwidth resources with network 400. As one specific example, a UE (e.g., UE 902) may be configured to operate in both network 900 and network 400. Such configuration may be based on a UE including circuitry configured for communication with frequency and bandwidth resources of both networks 400 and 900. In general, several elements of network 900 may share one or more characteristics with elements of network 400. For the sake of brevity and clarity, such elements may not be repeated in the description of network 900.

The network 900 may include a UE 902, which may include any mobile or non-mobile computing device designed to communicate with a RAN 908 via an over-the-air connection. The UE 902 may be similar to, for example, UE 402. The UE 902 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 9, in some embodiments the network 900 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 9, the UE 902 may be communicatively coupled with an AP such as AP 406 as described with respect to FIG. 4. Additionally, although not specifically shown in FIG. 9, in some embodiments the RAN 908 may include one or more ANss such as AN 408 as described with respect to FIG. 4. The RAN 908 and/or the AN of the RAN 908 may be referred to as a base station (BS), a RAN node, or using some other term or name.

The UE 902 and the RAN 908 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mm Wave” frequency ranges.

The RAN 908 may allow for communication between the UE 902 and a 6G core network (CN) 910. Specifically, the RAN 908 may facilitate the transmission and reception of data between the UE 902 and the 6G CN 910. The 6G CN 910 may include various functions such as NSSF 450, NEF 452, NRF 454, PCF 456, UDM 458, AF 460, SMF 446, and AUSF 442. The 6G CN 910 may additional include UPF 448 and DN 436 as shown in FIG. 9.

Additionally, the RAN 908 may include various additional functions that are in addition to, or alternative to, functions of a legacy cellular network such as a 4G or 5G network. Two such functions may include a Compute Control Function (Comp CF) 924 and a Compute Service Function (Comp SF) 936. The Comp CF 924 and the Comp SF 936 may be parts or functions of the Computing Service Plane. Comp CF 924 may be a control plane function that provides functionalities such as management of the Comp SF 936, computing task context generation and management (e.g., create, read, modify, delete), interaction with the underlying computing infrastructure for computing resource management, etc.. Comp SF 936 may be a user plane function that serves as the gateway to interface computing service users (such as UE 902) and computing nodes behind a Comp SF instance. Some functionalities of the Comp SF 936 may include: parse computing service data received from users to compute tasks executable by computing nodes; hold service mesh ingress gateway or service API gateway; service and charging policies enforcement; performance monitoring and telemetry collection, etc. In some embodiments, a Comp SF 936 instance may serve as the user plane gateway for a cluster of computing nodes. A Comp CF 924 instance may control one or more Comp SF 936 instances.

Two other such functions may include a Communication Control Function (Comm CF) 928 and a Communication Service Function (Comm SF) 938, which may be parts of the Communication Service Plane. The Comm CF 928 may be the control plane function for managing the Comm SF 938, communication sessions creation/configuration/releasing, and managing communication session context. The Comm SF 938 may be a user plane function for data transport. Comm CF 928 and Comm SF 938 may be considered as upgrades of SMF 446 and UPF 448, which were described with respect to a 5G system in FIG. 4. The upgrades provided by the Comm CF 928 and the Comm SF 938 may enable service-aware transport. For legacy (e.g., 4G or 5G) data transport, SMF 446 and UPF 448 may still be used.

Two other such functions may include a Data Control Function (Data CF) 922 and Data Service Function (Data SF) 932 may be parts of the Data Service Plane. Data CF 922 may be a control plane function and provides functionalities such as Data SF 932 management, Data service creation/configuration/releasing, Data service context management, etc. Data SF 932 may be a user plane function and serve as the gateway between data service users (such as UE 902 and the various functions of the 6G CN 910) and data service endpoints behind the gateway. Specific functionalities may include: parse data service user data and forward to corresponding data service endpoints, generate charging data, report data service status.

Another such function may be the Service Orchestration and Chaining Function (SOCF) 920, which may discover, orchestrate and chain up communication/computing/data services provided by functions in the network. Upon receiving service requests from users, SOCF 920 may interact with one or more of Comp CF 924, Comm CF 928, and Data CF 922 to identify Comp SF 936, Comm SF 938, and Data SF 932 instances, configure service resources, and generate the service chain, which could contain multiple Comp SF 936, Comm SF 938, and Data SF 932 instances and their associated computing endpoints. Workload processing and data movement may then be conducted within the generated service chain. The SOCF 920 may also responsible for maintaining, updating, and releasing a created service chain.

Another such function may be the service registration function (SRF) 914, which may act as a registry for system services provided in the user plane such as services provided by service endpoints behind Comp SF 936 and Data SF 932 gateways and services provided by the UE 902. The SRF 914 may be considered a counterpart of NRF 454, which may act as the registry for network functions.

Other such functions may include an evolved service communication proxy (eSCP) and service infrastructure control function (SICF) 926, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 912 and eSCP-U 934, for control plane service communication proxy and user plane service communication proxy, respectively. The SICF 926 may control and configure eCSP instances in terms of service traffic routing policies, access rules, load balancing configurations, performance monitoring, etc.

Another such function is the AMF 944. The AMF 944 may be similar to 444, but with additional functionality. Specifically, the AMF 944 may include potential functional repartition, such as move the message forwarding functionality from the AMF 944 to the RAN 908.

Another such function is the service orchestration exposure function (SOEF) 918. The SOEF may be configured to expose service orchestration and chaining services to external users such as applications.

The UE 902 may include an additional function that is referred to as a computing client service function (comp CSF) 904. The comp CSF 904 may have both the control plane functionalities and user plane functionalities, and may interact with corresponding network side functions such as SOCF 920, Comp CF 924, Comp SF 936, Data CF 922, and/or Data SF 932 for service discovery, request/response, compute task workload exchange, etc. The Comp CSF 904 may also work with network side functions to decide on whether a computing task should be run on the UE 902, the RAN 908, and/or an element of the 6G CN 910.

The UE 902 and/or the Comp CSF 904 may include a service mesh proxy 906. The service mesh proxy 906 may act as a proxy for service-to-service communication in the user plane. Capabilities of the service mesh proxy 906 may include one or more of addressing, security, load balancing, etc.

FIG. 10 illustrates a simplified block diagram of artificial (AI)-assisted communication between a UE 1005 and a RAN 1010, in accordance with various embodiments. More specifically, as described in further detail below, A1/machine learning (ML) models may be used or leveraged to facilitate over-the-air communication between UE 1005 and RAN 1010.

One or both of the UE 1005 and the RAN 1010 may operate in a matter consistent with 3GPP technical specifications or technical reports for 6G systems. In some embodiments, the wireless cellular communication between the UE 1005 and the RAN 1010 may be part of, or operate concurrently with, networks 900, 400, and/or some other network described herein.

The UE 1005 may be similar to, and share one or more features with, UE 902, UE 402, and/or some other UE described herein. The UE 1005 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc. The RAN 1010 may be similar to, and share one or more features with, RAN 414, RAN 908, and/or some other RAN described herein.

As may be seen in FIG. 10, the AI-related elements of UE 1005 may be similar to the AI-related elements of RAN 1010. For the sake of discussion herein, description of the various elements will be provided from the point of view of the UE 1005, however it will be understood that such discussion or description will apply to equally named/numbered elements of RAN 1010, unless explicitly stated otherwise.

As previously noted, the UE 1005 may include various elements or functions that are related to AI/ML. Such elements may be implemented as hardware, software, firmware, and/or some combination thereof. In embodiments, one or more of the elements may be implemented as part of the same hardware (e.g., chip or multi-processor chip), software (e.g., a computing program), or firmware as another element.

One such element may be a data repository 1015. The data repository 1015 may be responsible for data collection and storage. Specifically, the data repository 1015 may collect and store RAN configuration parameters, measurement data, performance key performance indicators (KPIs), model performance metrics, etc., for model training, update, and inference. More generally, collected data is stored into the repository. Stored data can be discovered and extracted by other elements from the data repository 1015. For example, as may be seen, the inference data selection/filter element 1050 may retrieve data from the data repository 1015. In various embodiments, the UE 1005 may be configured to discover and request data from the data repository 1010 in the RAN, and vice versa. More generally, the data repository 1015 of the UE 1005 may be communicatively coupled with the data repository 1015 of the RAN 1010 such that the respective data repositories of the UE and the RAN may share collected data with one another.

Another such element may be a training data selection/filtering functional block 1020. The training data selection/filter functional block 1020 may be configured to generate training, validation, and testing datasets for model training. Training data may be extracted from the data repository 1015. Data may be selected/filtered based on the specific AI/ML model to be trained. Data may optionally be transformed/augmented/pre-processed (e.g., normalized) before being loaded into datasets. The training data selection/filter functional block 1020 may label data in datasets for supervised learning. The produced datasets may then be fed into model training the model training functional block 1025.

As noted above, another such element may be the model training functional block 1025. This functional block may be responsible for training and updating (re-training) AI/ML models. The selected model may be trained using the fed-in datasets (including training, validation, testing) from the training data selection/filtering functional block. The model training functional block 1025 may produce trained and tested AI/ML models which are ready for deployment. The produced trained and tested models can be stored in a model repository 1035.

The model repository 1035 may be responsible for AI/ML models' (both trained and un-trained) storage and exposure. Trained/updated model(s) may be stored into the model repository 1035. Model and model parameters may be discovered and requested by other functional blocks (e.g., the training data selection/filter functional block 1020 and/or the model training functional block 1025). In some embodiments, the UE 1005 may discover and request AI/ML models from the model repository 1035 of the RAN 1010. Similarly, the RAN 1010 may be able to discover and/or request AI/ML models from the model repository 1035 of the UE 1005. In some embodiments, the RAN 1010 may configure models and/or model parameters in the model repository 1035 of the UE 1005.

Another such element may be a model management functional block 1040. The model management functional block 1040 may be responsible for management of the AI/ML model produced by the model training functional block 1025. Such management functions may include deployment of a trained model, monitoring model performance, etc. In model deployment, the model management functional block 1040 may allocate and schedule hardware and/or software resources for inference, based on received trained and tested models. As used herein, “inference” refers to the process of using trained AI/ML model(s) to generate data analytics, actions, policies, etc. based on input inference data. In performance monitoring, based on wireless performance KPIs and model performance metrics, the model management functional block 1040 may decide to terminate the running model, start model re-training, select another model, etc. In embodiments, the model management functional block 1040 of the RAN 1010 may be able to configure model management policies in the UE 1005 as shown.

Another such element may be an inference data selection/filtering functional block 1050. The inference data selection/filter functional block 1050 may be responsible for generating datasets for model inference at the inference functional block 1045, as described below. Specifically, inference data may be extracted from the data repository 1015. The inference data selection/filter functional block 1050 may select and/or filter the data based on the deployed AI/ML model. Data may be transformed/augmented/pre-processed following the same transformation/augmentation/pre-processing as those in training data selection/filtering as described with respect to functional block 1020. The produced inference dataset may be fed into the inference functional block 1045.

Another such element may be the inference functional block 1045. The inference functional block 1045 may be responsible for executing inference as described above. Specifically, the inference functional block 1045 may consume the inference dataset provided by the inference data selection/filtering functional block 1050, and generate one or more outcomes. Such outcomes may be or include data analytics, actions, policies, etc. The outcome(s) may be provided to the performance measurement functional block 1030.

The performance measurement functional block 1030 may be configured to measure model performance metrics (e.g., accuracy, model bias, run-time latency, etc.) of deployed and executing models based on the inference outcome(s) for monitoring purpose. Model performance data may be stored in the data repository 1015.

In some embodiments, the electronic device(s), network(s), system(s), chip(s) or component(s), or portions or implementations thereof, of FIGS. 4-10, or some other figure herein, may be configured to perform one or more processes, techniques, or methods as described herein, or portions thereof.

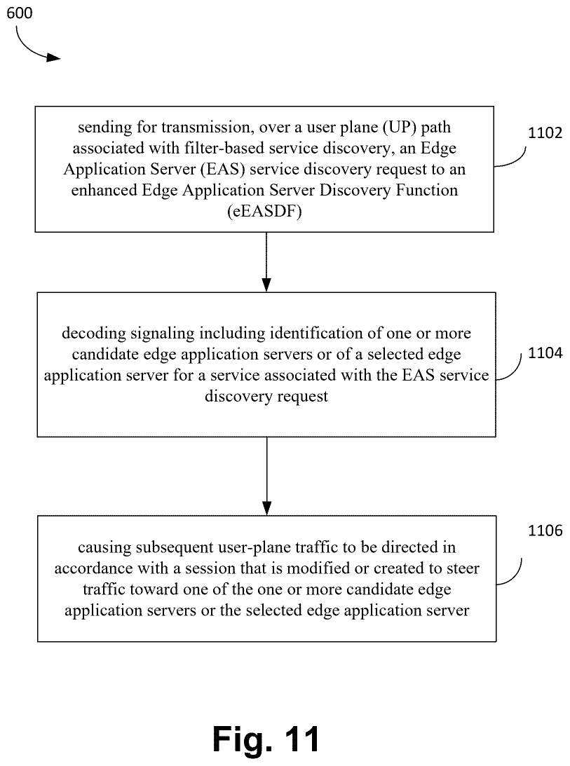

One such process 1100 is depicted in FIG. 11. For example, the process may include, at operation 1102, sending for transmission, over a user plane (UP) path associated with filter-based service discovery, an Edge Application Server (EAS) service discovery request to an enhanced Edge Application Server Discovery Function (eEASDF), at operation 1104, decoding signaling including identification of one or more candidate edge application servers or of a selected edge application server for a service associated with the EAS service discovery request, and at operation 1106, causing subsequent user-plane traffic to be directed in accordance with a session that is modified or created to steer traffic toward one of the one or more candidate edge application servers or the selected edge application server.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1 includes an apparatus of a New Radio (NR) User Equipment (UE), the apparatus including processing circuitry and a radio frequency (RF) circuitry interface to couple the processing circuitry to UE RF circuitry, the processing circuitry to: send for transmission, over a user plane (UP) path associated with filter-based service discovery, an Edge Application Server (EAS) service discovery request to an enhanced Edge Application Server Discovery Function (eEASDF); decode signaling including identification of one or more candidate edge application servers or of a selected edge application server for a service associated with the EAS discovery request; and cause subsequent user-plane traffic to be directed in accordance with a session that is modified or created to steer traffic toward one of the one or more candidate edge application servers or the selected edge application server.

Example 2 includes the subject matter of Example 1, wherein the processing circuitry is to encode the EAS service discovery request based on filter-based service discovery configuration information and to cause to transmit, over the UP path, filter fields comprising at least one of an edge application server identifier (EASID), version, location scope, workload, compute resource requirements, quality-of-service objectives, a data network name (DNN), or a Single Network Slice Selection Assistance Information (S NSSAI).

Example 3 includes the subject matter of Example 1, wherein the processing circuitry is to include, in the EAS service discovery request or in subsequent signaling sent over the UP path, an indication that network-initiated PDU session modification on behalf of the UE is permitted to steer UP traffic toward a selected edge application server, and to decode, via access and mobility management signaling, a notification of a modification outcome.

Example 4 includes the subject matter of Example 1, wherein the processing circuitry is to cause to transmit a follow-up EAS service discovery request over the UP path and, request updated PCO; decode updated configuration information and re-determine the UP path based on the updated configuration information.

Example 5 includes the subject matter of Example 1, the processing circuitry to: encode and send for transmission a protocol data unit (PDU) session establishment request message including a request for the filter-based service discovery, where the filter-based service discovery is associated with a Protocol Configuration Option (PCO); decode configuration information, the configuration information based on one or more filters corresponding to the filter-based service discovery; and determine the UP path based on the configuration information.

Example 6 includes the subject matter of Example 5, wherein the PCO includes selectors comprising at least one of: a discovery protocol indicator, an eEASDF endpoint identifier comprising one or more of an Internet Protocol (IP) address, a port number, and a Uniform Resource Locator (URL), and one or more identifiers of discovery request templates; and wherein the processing circuitry is to configure the UE based on the configuration information, and to map the EAS service discovery request to the UP path according to the selectors.

Example 7 includes the subject matter of Example 6, wherein the processing circuitry is to direct discovery signaling and subsequent UP traffic along the UP path based on a classification according to the selectors and based on conformity to uplink classifier (ULCL) rules.

Example 8 includes the subject matter of Example 6, wherein the processing circuitry is to implement the configuration information without treating templates as advertised capabilities; decode signaling that includes a recommended selection and validity information; and cause UP traffic associated with the service to be directed according to the validity information.

Example 9 includes the subject matter of Example 2, wherein the processing circuitry is to decode signaling indicating that eEASDF selection is based on a network repository function (NRF) procedure, and to decode session steering information comprising at least one of ULCL updates, user plane function (UPF) reselection, data network name (DNN), and Single Network Slice Selection Assistance Information (S NSSAI), and cause subsequent UP traffic to be directed according to the session steering information.

Example 10 includes a method performed by a New Radio (NR) User Equipment (UE), the method comprising: causing transmission, over a user plane (UP) path associated with filter-based service discovery, of an Edge Application Server (EAS) service discovery request to an enhanced Edge Application Server Discovery Function (eEASDF); decoding signaling including identification of one or more candidate edge application servers or of a selected edge application server for a service associated with the EAS service discovery request; and directing subsequent UP traffic in accordance with a session that is modified or created to steer traffic toward one of the one or more candidate edge application servers or the selected edge application server.

Example 11 includes the subject matter of Example 10, comprising: causing transmission of a follow-up EAS service discovery request over the UP path; requesting updated Protocol Configuration Options (PCO); decoding updated configuration information; and re-determining the UP path based on the updated configuration information.

Example 12 includes the subject matter of Example 10, comprising, during packet data unit (PDU) session establishment: encoding and causing transmission of a PDU session establishment request message including a request for the filter-based service discovery, wherein the filter-based service discovery is associated with a Protocol Configuration Option (PCO); decoding configuration information, the configuration information based on one or more filters corresponding to the filter-based service discovery; and determining the UP path based on the configuration information.

Example 13 includes the subject matter of Example 12, wherein the PCO includes selectors comprising at least one of: a discovery protocol indicator, an eEASDF endpoint identifier comprising one or more of an Internet Protocol (IP) address, a port number, and a Uniform Resource Locator (URL), and one or more identifiers of discovery request templates; and comprising: configuring the UE based on the configuration information; and mapping the EAS service discovery request to the UP path according to the selectors.

Example 14 includes the subject matter of Example 13, comprising: directing discovery signaling and subsequent UP traffic along the UP path based on a classification according to the selectors and based on conformity to uplink classifier (ULCL) rules.

Example 15 includes a non-transitory computer-readable medium storing instructions that, when executed by one or more processors of a New Radio (NR) User Equipment (UE), cause the UE to perform a method comprising: sending for transmission, over a user plane (UP) path associated with filter-based service discovery, an Edge Application Server (EAS) service discovery request to an enhanced Edge Application Server Discovery Function (eEASDF); decoding signaling including identification of one or more candidate edge application servers or of a selected edge application server for a service associated with the EAS service discovery request; and causing subsequent UP traffic to be directed in accordance with a session that is modified or created to steer traffic toward one of the one or more candidate edge application servers or the selected edge application server.

Example 16 includes the subject matter of Example 15, wherein the instructions, when executed, further cause the UE to: cause transmission of a follow-up EAS service discovery request over the UP path; request updated Protocol Configuration Options (PCO); decode updated configuration information; and re-determine the UP path based on the updated configuration information.

Example 17 includes the subject matter of Example 15, wherein the instructions, when executed, further cause the UE, during packet data unit (PDU) session establishment, to: encode and send for transmission a PDU session establishment request message including a request for the filter-based service discovery, wherein the filter-based service discovery is associated with a Protocol Configuration Option (PCO); decode configuration information, the configuration information based on one or more filters corresponding to the filter-based service discovery; and determine the UP path based on the configuration information.

Example 18 includes the subject matter of Example 17, wherein the instructions, when executed, further cause the UE to: decode PCO that includes selectors comprising at least one of: a discovery protocol indicator, an eEASDF endpoint identifier comprising one or more of an Internet Protocol (IP) address, a port number, and a Uniform Resource Locator (URL), and one or more identifiers of discovery request templates; configure the UE based on the configuration information; and map the EAS service discovery request to the UP path according to the selectors.

Example 19 includes the subject matter of Example 18, wherein the instructions, when executed, further cause the UE to: direct discovery signaling and subsequent UP traffic along the UP path based on a classification according to the selectors; and direct discovery signaling and subsequent UP traffic along the UP path based on conformity to uplink classifier (ULCL) rules.

Example 21 includes a non-transitory computer-readable medium storing instructions that, when executed by one or more processors of an enhanced Edge Application Server Discovery Function (eEASDF), cause the eEASDF to perform operations comprising: receiving, over a user plane (UP) path associated with filter-based service discovery, an Edge Application Server (EAS) service discovery request from a User Equipment (UE); parsing the service discovery request including one or more filter fields specifying at least a service identifier and one or more of a location scope, workload type, compute resource requirements, quality-of-service (QOS) objectives, a data network name (DNN), and a Single Network Slice Selection Assistance Information (S-NSSAI); querying a repository comprising a Unified Data Repository (UDR) or a Service Repository Function (SRF) to obtain a candidate set of EAS instances that satisfy the filter fields; generating a discovery response identifying one or more candidate EAS instances or a selected EAS instance for the requested service; and transmitting, toward the UE, the discovery response.

Example 22 includes the subject matter of Example 21, wherein the instructions, when executed, further cause the eEASDF to: evaluate repository results using policy constraints to refine the candidate set or determine a recommended selection, the policy constraints comprising at least one of slice admission, roaming or federation rules, Data Network Access Identifier (DNAI) preferences, or QoS objectives; and include in the discovery response validity information comprising at least a DNAI scope and a time-to-live (TTL).

Example 23 includes the subject matter of Example 21, wherein the instructions, when executed, further cause the eEASDF to: trigger, based on the selected EAS instance, a packet data unit (PDU) session modification by sending a request to a Session Management Function (SMF) to add or delete uplink classifier (ULCL) rules and/or to reselect or reconfigure a user plane function (UPF); and include in the request at least a cause value, a location context, Qos information, the DNN, and the S-NSSAI.

Example 24 includes the subject matter of Example 21, wherein the instructions, when executed, further cause the eEASDF to: when name resolution is applicable, include in the discovery response a mapping comprising a Fully Qualified Domain Name (FQDN) and an Internet Protocol (IP) address of the selected EAS; and during application of user-plane updates, temporarily buffer or suppress name-resolution responses associated with the selection until the user-plane updates complete, and thereafter release updated resolution information to the UE.

Example 25 includes the subject matter of Example 21, wherein the instructions, when executed, further cause the eEASDF to: subscribe to repository updates for EAS context including static profiles and dynamic telemetry comprising at least end-to-end (E2E) delay and computing resource occupancy; upon detecting a significant update affecting a previously issued discovery response, prompt rediscovery by providing revised candidate information or by causing updated configuration to be delivered to the UE; and cache repository results with freshness indicators to prioritize candidates having recent telemetry within a declared validity scope.

Example 26 includes an apparatus hosting an enhanced Edge Application Server Discovery Function (eEASDF), the apparatus comprising one or more processors and one or more memories storing instructions that, when executed by the one or more processors, cause the eEASDF to: receive, over a user plane (UP) path associated with filter-based service discovery, an Edge Application Server (EAS) service discovery request from a User Equipment (UE); parse filter fields of the request specifying at least a service identifier and one or more of a location scope, workload type, compute resource requirements, QoS objectives, a DNN, and an S-NSSAI; and query a repository comprising a UDR or an SRF to obtain a candidate set of EAS instances that satisfy the filter fields and generate a discovery response identifying one or more candidate EAS instances or a selected EAS instance.

Example 27 includes the subject matter of Example 26, wherein the instructions, when executed, further cause the eEASDF to: apply policy constraints to refine candidates or determine a recommended selection; and include validity information comprising at least a DNAI scope and a TTL in the discovery response.

Example 28 includes the subject matter of Example 26, wherein the instructions, when executed, further cause the eEASDF to: trigger a PDU session modification by sending, to an SMF, a request to add or delete ULCL rules and/or to reselect or reconfigure a UPF; and include in the request at least a cause value, a location context, QoS information, the DNN, and the S-NSSAI.

Example 29 includes the subject matter of Example 26, wherein the instructions, when executed, further cause the eEASDF to: provide, where applicable, an FQDN-to-IP mapping for a selected EAS in the discovery response; and temporarily buffer or suppress name-resolution responses associated with the selection until user-plane updates complete, then release updated resolution information.

Example 30 includes the subject matter of Example 26, wherein the instructions, when executed, further cause the eEASDF to: subscribe to repository updates for EAS context including E2E delay and computing resource occupancy; initiate rediscovery or provide revised candidates upon significant context changes; and cache repository results with freshness indicators and select candidates within a declared validity scope.

Example 31 includes a method performed by an enhanced Edge Application Server Discovery Function (eEASDF), the method comprising: receiving, over a user plane (UP) path associated with filter-based service discovery, an Edge Application Server (EAS) service discovery request from a User Equipment (UE); parsing the service discovery request including filter fields specifying at least a service identifier and one or more of a location scope, workload type, compute resource requirements, quality-of-service (QOS) objectives, a data network name (DNN), and a Single Network Slice Selection Assistance Information (S-NSSAI); querying a repository comprising a Unified Data Repository (UDR) or a Service Repository Function (SRF) to obtain a candidate set of EAS instances that satisfy the filter fields; and generating and transmitting, toward the UE, a discovery response identifying one or more candidate EAS instances or a selected EAS instance for the requested service.

Example 32 includes the subject matter of Example 31, further comprising: applying policy constraints to refine the candidate set or determine a recommended selection; and including in the discovery response validity information comprising at least a Data Network Access Identifier (DNAI) scope and a time-to-live (TTL).

Example 33 includes the subject matter of Example 31, further comprising: triggering, based on the selected EAS instance, a packet data unit (PDU) session modification by sending a request to a Session Management Function (SMF) to add or delete uplink classifier (ULCL) rules and/or to reselect or reconfigure a user plane function (UPF); and including in the request at least a cause value, a location context, QoS information, the DNN, and the S-NSSAI.

Example 34 includes the subject matter of Example 31, further comprising: when name resolution is applicable, including in the discovery response a mapping comprising a Fully Qualified Domain Name (FQDN) and an Internet Protocol (IP) address of the selected EAS; and during application of user-plane updates, temporarily buffering or suppressing name-resolution responses associated with the selection until the user-plane updates complete, and thereafter releasing updated resolution information to the UE.

Example 35 includes the subject matter of Example 31, further comprising: subscribing to repository updates for EAS context including static profiles and dynamic telemetry comprising at least end-to-end (E2E) delay and computing resource occupancy; upon detecting a significant update affecting a previously issued discovery response, prompting rediscovery by providing revised candidate information or by causing updated configuration to be delivered to the UE; and caching repository results with freshness indicators to prioritize candidates having recent telemetry within a declared validity scope.

Example Y1 includes the enhanced EASDF (eEASDF) in the next generation cellular network performs EAS discovery based on the PCO configurations from the cellular network.

Example Y2 includes the method of example 1 and/or some other example herein, wherein the AMF receives a PCO request from the UE in a NAS message such as a PDU session establishment request and sends the PCO response in a NAS message such as a PDU session establishment response.

Example Y3 includes the method of example 2 and/or some other example herein, wherein the PCO sent from the cellular network include the information about an eEASDF such as IP address, port number, supported protocols, service discovery filters, etc. as described in 5.1.1.

Example Y4 includes the method of example 1 and/or some other example herein, wherein the eEASDF receives an EAS discovery message via UP from the UE including a filter to generate EAS candidate list.

Example Y5 includes the method of example 4 and/or some other example herein, wherein the eEASDF receives an EAS discovery message indicating that a PDU session modification is allowed to be performed on behalf of UE based on the selected EAS.

Example Y6 includes the method of example 4 and/or some other example herein, wherein the eEASDF queries the UDR or SRF to obtain an EAS candidate list based on the filter received from the UE.

Example Y7 includes the eEASDF sends a PDU session modification request to the SMF to request PDU session modification based on the selected EAS for the UE.

Example Y8 includes the method of example 6 and/or some other example herein, wherein the eEASDF requests the add/delete of ULCL or UPF reselection for a PDU session based on the EAS selection for the UE.

Example Y9 includes the method of example 7 and/or some other example herein, wherein the information about the selected EAS is sent from the eEASDF to the UE

Example Z01 includes an apparatus comprising means to perform one or more elements of a method described in or related to any of examples 1-9, and/or any other method or process described herein.

Example Z02 includes one or more non-transitory computer-readable media comprising instructions to cause an electronic device, upon execution of the instructions by one or more processors of the electronic device, to perform one or more elements of a method described in or related to any of examples 1-9, and/or any other method or process described herein.

Example Z03 includes an apparatus comprising logic, modules, or circuitry to perform one or more elements of a method described in or related to any of examples 1-9, and/or any other method or process described herein.

Example Z04 includes a method, technique, or process as described in or related to any of examples 1-9, and/or portions or parts thereof.

Example Z05 includes an apparatus comprising: one or more processors and one or more computer-readable media comprising instructions that, when executed by the one or more processors, cause the one or more processors to perform the method, techniques, or process as described in or related to any of examples 1-9, and/or portions thereof.

Example Z06 includes a signal as described in or related to any of examples 1-9, or portions or parts thereof.

Example Z07 includes a datagram, packet, frame, segment, protocol data unit (PDU), or message as described in or related to any of examples 1-9, and/or portions or parts thereof, or otherwise described in the present disclosure.

Example Z08 includes a signal encoded with data as described in or related to any of examples 1-9, and/or portions or parts thereof, or otherwise described in the present disclosure.

Example Z09 includes a signal encoded with a datagram, packet, frame, segment, protocol data unit (PDU), or message as described in or related to any of examples 1-9, and/or portions or parts thereof, or otherwise described in the present disclosure.

Example Z10 includes an electromagnetic signal carrying computer-readable instructions, wherein execution of the computer-readable instructions by one or more processors is to cause the one or more processors to perform the method, techniques, or process as described in or related to any of examples 1-9, and/or portions thereof.

Example Z11 includes a computer program comprising instructions, wherein execution of the program by a processing element is to cause the processing element to carry out the method, techniques, or process as described in or related to any of examples 1-9, and/or portions thereof.

Example Z12 includes a signal in a wireless network as shown and described herein.

Example Z13 includes a method of communicating in a wireless network as shown and described herein.

Example Z14 includes a system for providing wireless communication as shown and described herein.

Example Z15 includes a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

What is claimed is:

1. An apparatus of a New Radio (NR) User Equipment (UE), the apparatus including processing circuitry and a radio frequency (RF) circuitry interface to couple the processing circuitry to UE RF circuitry, the processing circuitry to:
send for transmission, over a user plane (UP) path associated with filter-based service discovery, an Edge Application Server (EAS) service discovery request to an enhanced Edge Application Server Discovery Function (eEASDF);
decode signaling including identification of one or more candidate edge application servers or of a selected edge application server for a service associated with the EAS discovery request; and
cause subsequent user-plane traffic to be directed in accordance with a session that is modified or created to steer traffic toward one of the one or more candidate edge application servers or the selected edge application server.

2. The apparatus of claim 1, wherein the processing circuitry is to encode the EAS service discovery request based on filter-based service discovery configuration information and to cause to transmit, over the UP path, filter fields comprising at least one of an edge application server identifier (EASID), version, location scope, workload, compute resource requirements, quality-of-service objectives, a data network name (DNN), or a Single Network Slice Selection Assistance Information (S-NSSAI).

3. The apparatus of claim 1, wherein the processing circuitry is to include, in the EAS service discovery request or in subsequent signaling sent over the UP path, an indication that network-initiated PDU session modification on behalf of the UE is permitted to steer UP traffic toward a selected edge application server, and to decode, via access and mobility management signaling, a notification of a modification outcome.

4. The apparatus of claim 1, wherein the processing circuitry is to cause to transmit a follow-up EAS service discovery request over the UP path and, request updated PCO; decode updated configuration information and re-determine the UP path based on the updated configuration information.

5. The apparatus of claim 1, the processing circuitry to:
encode and send for transmission a protocol data unit (PDU) session establishment request message including a request for the filter-based service discovery, where the filter-based service discovery is associated with a Protocol Configuration Option (PCO);
decode configuration information, the configuration information based on one or more filters corresponding to the filter-based service discovery; and
determine the UP path based on the configuration information, wherein the UP path corresponds to a dedicated PDU session for service discovery traffic to the eEASDF.

6. The apparatus of claim 5, wherein the PCO includes selectors comprising at least one of: a discovery protocol indicator, an eEASDF endpoint identifier comprising one or more of an Internet Protocol (IP) address, a port number, and a Uniform Resource Locator (URL), and one or more identifiers of discovery request templates; and wherein the processing circuitry is to configure the UE based on the configuration information, and to map the EAS service discovery request to the UP path according to the selectors, including mapping the EAS service discovery request to the dedicated PDU session.

7. The apparatus of claim 6, wherein the processing circuitry is to implement the configuration information without treating templates as advertised capabilities; decode signaling that includes a recommended selection and validity information; and cause UP traffic associated with the service to be directed according to the validity information.

8. The apparatus of claim 7, wherein the processing circuitry is to direct discovery signaling and subsequent UP traffic along the UP path based on a classification according to the selectors and based on conformity to uplink classifier (ULCL) rules, wherein the validity information comprises at least one of a Data Network Access Identifier (DNAI) scope or a time-to-live (TTL).

9. The apparatus of claim 2, wherein the processing circuitry is to decode signaling indicating that eEASDF selection is based on a network repository function (NRF) procedure, and that identification of the one or more candidate or selected edge application servers is derived from repository context stored in a Unified Data Repository (UDR) or a Service Repository Function (SRF), the repository context comprising static profile information and dynamic telemetry including at least end-to-end (E2E) delay and computing resource occupancy, and to decode session steering information comprising at least one of ULCL updates, user plane function (UPF) reselection, data network name (DNN), and Single Network Slice Selection Assistance Information (S-NSSAI), and cause subsequent UP traffic to be directed according to the session steering information.

10. A non-transitory computer-readable medium storing instructions that, when executed by one or more processors of a core network comprising an enhanced Edge Application Server Discovery Function (eEASDF), cause the core network to perform operations comprising:
receiving, over a user plane (UP) path associated with filter-based service discovery, an Edge Application Server (EAS) service discovery request from a User Equipment (UE);
parsing the service discovery request to identify one or more filter fields specifying at least a service identifier and one or more of a location scope, workload type, compute resource requirements, quality-of-service (QOS) objectives, a data network name (DNN), and a Single Network Slice Selection Assistance Information (S-NSSAI);
querying a repository comprising at least one of a Unified Data Repository (UDR) or a Service Repository Function (SRF) to obtain a candidate set of EAS instances that satisfy the filter fields;
generating a discovery response identifying one or more candidate EAS instances or a selected EAS instance for the requested service; and
transmitting, toward the UE, the discovery response together with session steering information to direct subsequent UP traffic toward the candidate or selected EAS instance.

11. The non-transitory computer-readable medium of claim 10, wherein the instructions, when executed, further cause the core network to integrate metadata and dynamic telemetry from the UDR or SRF, the metadata and telemetry comprising at least end-to-end (E2E) delay and computing resource occupancy, and to evaluate the integrated data to refine the candidate set or determine a recommended selection for the requested service.

12. The non-transitory computer-readable medium of claim 10, wherein the instructions, when executed, further cause the core network to obtain EAS-related information for service discovery using Hypertext Transfer Protocol (HTTP)-based information filters, and to apply the HTTP-based filters to repository records to produce the candidate set identified in the discovery response.

13. The non-transitory computer-readable medium of claim 10, wherein the instructions, when executed, further cause the core network to trigger a packet data unit (PDU) session modification by sending a request to a Session Management Function (SMF) to add or delete uplink classifier (ULCL) rules and/or to reselect or reconfigure a user plane function (UPF), the request including at least a cause value, a location context, QoS information, the DNN, and the S-NSSAI.

14. The non-transitory computer-readable medium of claim 10, wherein the instructions, when executed, further cause the core network to include, in the discovery response, validity information comprising at least a Data Network Access Identifier (DNAI) scope and a time-to-live (TTL), to temporarily buffer or suppress name-resolution responses associated with a selection until user-plane updates complete, and thereafter to release updated resolution information to the UE; and to subscribe to repository updates for EAS context and prompt a rediscovery by providing revised candidate information upon detecting a significant context change.

15. A non-transitory computer-readable medium storing instructions that, when executed by one or more processors of a New Radio (NR) User Equipment (UE), cause the one or more processors to perform operations including sending for transmission, over a user plane (UP) path associated with filter-based service discovery, an Edge Application Server (EAS) service discovery request to an enhanced Edge Application Server Discovery Function (eEASDF).

16. The non-transitory computer-readable medium of claim 15, wherein the instructions, when executed, further cause the one or more processors to:
decode signaling including identification of one or more candidate edge application servers or of a selected edge application server for a service associated with the EAS service discovery request; and
cause subsequent UP traffic to be directed in accordance with a session that is modified or created to steer traffic toward one of the one or more candidate edge application servers or the selected edge application server.

17. The non-transitory computer-readable medium of claim 15, wherein the instructions, when executed, further cause the one or more processors to:
cause transmission of a follow-up EAS service discovery request over the UP path;
request updated Protocol Configuration Options (PCO);
decode updated configuration information; and
re-determine the UP path based on the updated configuration information.

18. The non-transitory computer-readable medium of claim 15, wherein the instructions, when executed, further cause the one or more processors, during packet data unit (PDU) session establishment, to:
encode and send for transmission a PDU session establishment request message including a request for the filter-based service discovery, wherein the filter-based service discovery is associated with a Protocol Configuration Option (PCO);
decode configuration information, the configuration information based on one or more filters corresponding to the filter-based service discovery; and
determine the UP path based on the configuration information.

19. The non-transitory computer-readable medium of claim 17, wherein the instructions, when executed, further cause the one or more processors to:
decode PCO that includes selectors comprising at least one of: a discovery protocol indicator, an eEASDF endpoint identifier comprising one or more of an Internet Protocol (IP) address, a port number, and a Uniform Resource Locator (URL), and one or more identifiers of discovery request templates;
configure the UE based on the configuration information; and
map the EAS service discovery request to the UP path according to the selectors.

20. The non-transitory computer-readable medium of claim 19, wherein the instructions, when executed, further cause the one or more processors to:
direct discovery signaling and subsequent UP traffic along the UP path based on a classification according to the selectors; and
direct discovery signaling and subsequent UP traffic along the UP path based on conformity to uplink classifier (ULCL) rules.
